(19) United States
(12) Patent Application Publication
(10) Pub. No.: US 2023/0160553 A1
(43) Pub. Date: May 25, 2023

(54) REFLECTION-TYPE HEADLAMP MODULE, HEADLAMP MODULE, HEADLAMP AND VEHICLE

(71) Applicant: HASCO VISION TECHNOLOGY CO., LTD., Shanghai (CN)

(72) Inventor: Jie ZHANG, Shanghai (CN)

(21) Appl. No.: 18/086,831

(22) Filed: Dec. 22, 2022

Related U.S. Application Data
(63) Continuation-in-part of application No. 17/421,094, filed on Jul. 7, 2021.

(30) Foreign Application Priority Data
Nov. 13, 2019 (CN) 201921964268.1
Nov. 13, 2019 (CN) 201921964269.6
Nov. 13, 2019 (CN) 201921964270.9
Nov. 13, 2019 (CN) 201921964391.3
Nov. 13, 2019 (CN) 201921972597.0
Nov. 13, 2019 (CN) 201921972599.X

(51) Int. Cl. F21S 41/365; F21S 41/143; F21S 41/147; F21S 41/255; F21S 41/32; F21S 41/43

(52) U.S. Cl. CPC F21S 41/365; F21S 41/143; F21S 41/147; F21S 41/255; F21S 41/321; F21S 41/43; F21W 2102/135

(57) ABSTRACT

The present disclosure relates to vehicle lamps, and discloses a reflection-type headlamp module, comprising a light source, a light-collimating element, a reflecting element, and a lens, wherein the light-collimating element is suitable for converging light emitted by the light source and projecting the light; and the reflecting element is arranged on an emergent light path of the light-collimating element, so as to be suitable for reflecting the light emitted by the light source to the lens, and the light is projected by the lens to form an illuminating light pattern. The present disclosure further discloses a headlamp module. Besides, the present disclosure further discloses a headlamp and a vehicle using the headlamp.

### CROSS REFERENCE TO RELATED APPLICATION

The present application is a continuation-in-part application of US patent application US2022/0107070. This US patent application US2022/0107070 is a US National Phase application of the International Application PCT/CN2020/079188 filed by the applicant on Mar. 13, 2020, and entitled “Reflection-type Headlamp Module, Headlamp Module, Headlamp and Vehicle”, and claims the benefits of the Chinese patent applications 201921964391.3, 201921964270.9, 201921964269.6, 201921972599.X, 201921964268.1, and 201921972597.0 filed on Nov. 13, 2019, and the contents of the six applications are incorporated herein by reference.

### TECHNICAL FIELD

The present disclosure relates to vehicle lamps and particularly relates to a reflection-type headlamp module. In addition, the present disclosure further relates to a headlamp module, a headlamp, and a vehicle.

### BACKGROUND ART

As shown in FIG. 1, an existing headlamp module generally includes a light source 1, a reflecting cup 2a, a light shielding plate 5 and a lens 4. A light emitting center of the light source 1 is arranged on a first focus of the reflecting cup 2a shaped like an ellipsoid-like surface, light nearly subjected to Lambertian divergence and emitted by the light source 1 is converged to a second focus of the reflecting cup 2a by the reflecting cup 2a, is shielded by a light shielding part, corresponding to a low-beam light pattern, arranged on the light shielding plate 5 to form a bright-dark boundary and is then imaged on a road surface by the lens 4. Generally, a focus of the lens 4 is arranged on the second focus of the reflecting cup 2a, while the light source 1, the first focus of the reflecting cup 2a, the second focus of the reflecting cup 2a and optical axes of the lens 4 are arranged on the same straight line, and therefore, the front and rear length of the headlamp module is inevitably greater than the sum of a focal length f1 of the lens 4 and a distance f2 from the first focus to the second focus of the reflecting cup. In this way, the front and rear length of the headlamp module is restricted, the front and rear diameter of a headlamp with the headlamp module is relatively large and may not be freely reduced according to a design requirement, and thus, the shape design for the headlamp is affected.

For an existing headlamp module capable of achieving a low-beam function and a high-beam function, switching between high-beam light and low-beam light is generally realized by performing position switching on a light shielding plate for forming a low-beam bright-dark cutoff line. Such a headlamp module is generally is formed by a reflecting cup of ellipsoid-like surface with two foci including a far focus and a near focus in combination with the light shielding plate and an alignment lens; the far focus, namely a focus far from the alignment lens, of the reflecting cup is used for setting a light source, the near focus of the reflecting cup is arranged near a focus of the alignment lens; the light shielding plate is arranged on the focus of the alignment lens, in this case, divergent light emitted by the light source is converged near the near focus of the reflecting cup after being reflected by the reflecting cup, is shielded by the light shielding plate to form a low-beam bright-dark cutoff line and is imaged on a road surface by the alignment lens; and when the high-beam light is required, position switching is performed on the light shielding plate by a driving mechanism, and the high-beam light is formed after the light shielding plate is moved away.

In the above way for switching the high-beam light and the low-beam light, there are following defects: 1, the position switching of the light shielding plate is required to be driven by the driving mechanism, and a switching process thereof is a mechanical motion process in which inherent defects such as abrasion, noise and low switching speed are easy to cause; and 2, the light shielding plate is arranged near the near focus of the reflecting cup, and the light emitted by the light source is converged hereon, such that the temperature of the light shielding plate at the position is relatively high due to high-energy radiation, so that defects such as looseness and clamping stagnation of the driving mechanism are easy to cause, the high-beam light and the low-beam light may not be switched in place, and even may not be switched, and the stability is poor.

For some headlamp modules capable of achieving a low-beam function and a high-beam function, a low-beam module and a high-beam module are respectively arranged, i.e., the low-beam module composed of a low-beam light source, a low-beam reflecting cup, a light shielding plate and an optical lens and a high-beam module composed of a high-beam light source, a high-beam reflecting cup (or a collimator) and an optical lens are respectively arranged. The low-beam module and the high-beam module generally share one optical lens. The low-beam module forms a low-beam light pattern of the headlamp module, and the high-beam module forms a high-beam light pattern of the headlamp module.

CN109282234A discloses a projection unit for an automobile low-beam lamp, applied to an optical system with single low-beam light. The projection unit for an automobile low-beam lamp includes a light source and an optical lens arranged in an exit direction of the low-beam lamp, a reflecting mirror is provided in an optical axis direction of the light source, and an upper end of the light reflecting mirror is provided with a cutoff line structure. When the light source illuminates the reflecting mirror, light reflected by the reflecting mirror forms a preliminary illumination light pattern, and then illuminates road surface through the optical lens to form a final secondary light pattern with a bright-dark cutoff line, that is, a low-beam light pattern. The projection unit can also realize the vehicle lamp function without the bright-dark cutoff line requirement, such as high-beam light, that is, a single high-beam optical system just by flipping setting positions of the light source and the reflecting mirror. However, if to achieve integration of high-beam light and low-beam light, high-beam light will be shielded by the low-beam optical system, and only a small part of high-beam light can be incident on the optical lens. Therefore, the optical system disclosed in CN109282234A can only realize low-beam light or high-beam light alone, and cannot realize the integration of high-beam light and low-beam light. If the optical system is forcibly turned into an optical system that can realize the integration of high-beam light and low-beam light, the high-beam light pattern will be affected and cannot meet regulatory requirements, thus the optical system disclosed in CN109282234A has the technical problem that the low-beam optical system blocks the high-beam light.

A light source, a primary optical element (a reflecting cup or a collimator and the like), a light shielding device and an optical lens of an existing headlamp module capable of achieving the low-beam function and the high-beam function are generally arranged back and forth in a line, a size of the module in the front and rear direction is relatively large, which results in a relatively large front and rear size of the headlamp, and therefore, the free design for the shape of the headlamp is affected.

For some high-beam and low-beam integrated headlamp modules, a mode of illuminating that a low-beam module forms a low-beam light pattern alone and the low-beam module and a high-beam module jointly form a high-beam light pattern is used. In such a case, the light shielding plate in the low-beam module is generally located on a light emitting path of the high-beam module to generate interference to the high-beam light pattern, and thus, an illuminating effect of the high-beam light is affected.

### SUMMARY

A technical problem to be solved by the present disclosure is to provide a reflection-type headlamp module of which a front and rear size can be effectively reduced.

A technical problem to be further solved by the present disclosure is to provide a headlamp module which is small in front and rear size and/or has convenience in switching between high-beam light and low-beam light.

A technical problem to be further solved by the present disclosure is to provide a headlamp which occupies smaller front and rear space and/or has convenience in switching between high-beam light and low-beam light.

A technical problem to be further solved by the present disclosure is to provide a vehicle, with a headlamp which occupies smaller front and rear space and/or has convenience in switching between high-beam light and low-beam light.

For solving the above technical problems, in a first aspect, the present disclosure provides a reflection-type headlamp module including a light source, a light-collimating element, a reflecting element and a lens; and the light-collimating element is suitable for converging light emitted by the light source and projecting the light, wherein the reflecting element is arranged on an emergent light path of the light-collimating element so as to be suitable for reflecting the light emitted by the light source to the lens, and the light is projected by the lens to form an illuminating light pattern.

Specifically, the reflecting element is a reflecting mirror.

Preferably, a reflecting surface of the reflecting element is a plane or a curved surface, and/or the reflecting surface of the reflecting element is provided with a highly reflective material layer. According to the preferred technical solution, the reflecting mirror with the reflecting surface being the plane is simple and convenient to machine and simple in light pattern formation way. By using the reflecting mirror with the reflecting surface being the curved surface, a specific part of an illuminating light pattern may be adjusted and optimized, so that the formed illuminating light pattern is more reasonable and an illuminating effect is better. By using the highly reflective material layer, a light reflecting effect of the reflecting mirror can be improved, a utilization ratio of the light emitted by the light source can be increased, and the brightness for the illuminating light pattern can be increased.

Preferably, the reflecting element is suitable for adjusting an included angle between the reflecting surface of the reflecting element and an optical axis of the lens. According to the preferred technical solution, a direction in which light irradiates to the lens after being reflected by the reflecting mirror may be adjusted by adjusting the included angle α between the reflecting surface of the reflecting mirror and the optical axis of the lens, and furthermore, a height of the position of the formed illuminating light pattern is adjusted.

As a preferred structural form, the reflection-type headlamp module is a low-beam reflection-type headlamp module in which a low-beam light propagation path is formed, the light source is a low-beam light source, the low-beam light source, the light-collimating element, the reflecting element and the lens are sequentially arranged on the low-beam light propagation path, the reflecting element is provided with a cutoff line structure for forming a bright-dark cutoff line, and light of the low-beam light source is suitable for being converged to the reflecting element by the light-collimating element, is reflected to the lens by the reflecting element and is projected by the lens to form an illuminating low-beam light pattern.

Preferably, a reflecting surface of the reflecting element is located on the emergent light path of the light-collimating element, and the cutoff line structure is arranged on an edge of an end, close to the light-collimating element, of the reflecting surface of the reflecting element.

Optionally, the light-collimating element is a reflecting cup, and the reflecting cup is shaped as a curved surface with a first focus and a second focus; or the reflecting element is a reflecting mirror.

Specifically optionally, the low-beam light source is located at the first focus of the reflecting cup used as the light-collimating element, and the cutoff line structure is located at the second focus of the reflecting cup; or the light-collimating element is a reflecting cup shaped as an ellipsoid surface, an ellipsoid-like surface, a paraboloid, or a paraboloid-like surface; or the reflecting element is a planar reflecting mirror or a curved-surface reflecting mirror.

Preferably, the light-collimating element is a reflecting cup, and the reflecting cup is shaped as a curved surface with a first focus and a second focus, wherein the light source is located at the first focus of the reflecting cup. In the preferred technical solution, the reflecting cup is simple in structure and capable of better converging the light emitted by the light source arranged at the first focus close to a bottom of the reflecting cup to the second focus far from the bottom of the reflecting cup.

Further preferably, an included angle between the optical axis of the reflecting cup and the optical axis of the lens is 60-120°. According to the preferred technical solution, the included angle between the optical axis of the reflecting cup and the optical axis of the lens is optimized, so that the front and rear length, namely a length in a direction of the optical axis of the lens, of the reflection-type headlamp module of the present disclosure can be smaller, deformation of the illuminating light pattern caused by the reflection by the reflecting mirror can be reduced, and meanwhile, interference generated between the lens on the position and the reflecting cup also can be avoided.

Further, the included angle between the optical axis of the reflecting cup and the optical axis of the lens is 90°. In the preferred technical solution, when the included angle between the optical axis of the reflecting cup and the optical axis of the lens is 90°, the front and rear length of the reflection-type headlamp module of the present disclosure is smaller, and the deformation of the illuminating light pattern caused by the reflection by the reflecting mirror is least. Meanwhile, the interference generated between the lens on the position and the reflecting cup cannot happen easily.

Preferably, the reflection-type headlamp module of the present disclosure further includes a light shielding plate. The light shielding plate is provided with a cutoff line structure, and the cutoff line structure is located at the second focus of the reflecting cup; or the reflecting cup is shaped as an ellipsoid surface or an ellipsoid-like surface. In the preferred technical solution, the light shielding plate is capable of shielding light emitted by the reflecting cup to form a bright-dark cutoff line of the illuminating light pattern. When the cutoff line structure is located near the second focus of the reflecting cup, a light shielding effect of the light shielding plate is good, and the bright-dark cutoff line is highly clear. The reflecting cup shaped as the ellipsoid surface or the ellipsoid-like surface is good in convergence performance due to the capability of better converging the light emitted by the light source located at the first focus to the second focus and convenient to machine. The ellipsoid-like surface is similar to the ellipsoid surface in shape, and is formed by certain adaptive adjustment for light pattern optimization on the basis of the shape of the ellipsoid surface.

Further preferably, a mirror point formed by the second focus of the reflecting cup relative to the reflecting surface of the reflecting element is located at a focus of the lens. In the preferred technical solution, light irradiating to the reflecting mirror after being converged by the reflecting cup is emitted to the lens after being reflected by the reflecting mirror, which is equivalent to that the light is directly emitted from the mirror point formed by the second focus of the reflecting cup relative to the reflecting surface of the reflecting mirror, namely the focus of the lens, to the lens and can be projected by the lens to form a clearer illuminating light pattern.

As a preferred structural form, the light-collimating element is a reflecting cup, and one side of the reflecting element is arranged or integrally molded on an edge of a light emergent opening in a light emergent direction of the reflecting cup; and the lens is located on a reflected light emergent path of the reflecting element, and the focus of the lens is located at the second focus of the reflecting cup. In the preferred technical solution, the reflecting mirror and the reflecting cup which are integrally connected are firmer in connection and more stable in structure, and a connection machining process is also omitted.

Preferably, an edge of a side, opposite to a side connected with the reflecting cup, of the reflecting element is provided with a cutoff line structure, and the cutoff line structure is located in a second focus region of the reflecting cup; or the reflecting cup is shaped as an ellipsoid surface or an ellipsoid-like surface. According to the preferred technical solution, by using the cutoff line structure, light converged to the second focus of the reflecting cup can be shielded so that a bright-dark cutoff line is formed. Meanwhile, since the cutoff line structure is arranged on the reflecting mirror, the stability of the bright-dark cutoff line is relatively high. The reflecting cup shaped as the ellipsoid surface or the ellipsoid-like surface is good in convergence performance due to the capability of better converging the light emitted by the light source located at the first focus to the second focus and convenient to machine.

Further preferably, the reflecting element is semi-ellipsoidal, an arc-shaped edge of the reflecting element is connected with the reflecting cup, and a straight line edge opposite to the arc-shaped edge is provided with the cutoff line structure. In the preferred technical solution, the arc-shaped edge of the semi-ellipsoidal reflecting mirror can be better connected with the reflecting cup, so that the connection is more stable.

Preferably, an included angle between a connecting line of the two foci of the reflecting cup and a mirror surface of the reflecting element is 30° to 60°. In the preferred technical solution, a direction in which light emitted by the reflecting cup is reflected by the reflecting mirror can be adjusted by setting the reasonable included angle between the connecting line of the two foci of the reflecting cup and the mirror surface of the reflecting mirror serving as the reflecting element, and thus, a reasonable position for the illuminating light pattern is formed on the basis that the front and rear diameter of the module is reduced.

In a second aspect, the present disclosure provides a headlamp module including the reflection-type headlamp module provided according to the first aspect of the present disclosure so as to be capable of achieving a low-beam function and a high-beam function.

Preferably, the headlamp module adopts the above reflection-type headlamp module in the first technical solution. The light-collimating element includes a low-beam collimating element and a high-beam collimating element; the light source includes a low-beam light source located at a first focus of the low-beam collimating element and a high-beam light source located at a first focus of the high-beam collimating element; the low-beam light source and the low-beam collimating element form a low-beam optical component including the low-beam light source and the low-beam collimating element; the high-beam light source and the high-beam collimating element form a high-beam optical component including the high-beam light source and the high-beam collimating element; the reflecting element is formed in a reflecting structure, a low-beam reflecting surface of the reflecting structure is located on an emergent light path of the low-beam optical component, and a high-beam reflecting surface of the reflecting structure is located on an emergent light path of the high-beam optical component; and emergent light of the low-beam optical component and the high-beam optical component can irradiate to the lens after being reflected by the reflecting structure and can be refracted by the lens to respectively form a low-beam light pattern and a high-beam light pattern. The reflecting structure is provided with a cutoff line structure for forming a bright-dark cutoff line, a focus of the lens is located in a region of the cutoff line structure, and a second focus of the low-beam collimating element and a second focus of the high-beam collimating element are both located in the region of the cutoff line structure.

More preferably, the cutoff line structure is formed at an included angle between the low-beam reflecting surface of the reflecting structure and the high-beam reflecting surface of the reflecting structure.

Further preferably, the low-beam reflecting surface is a plane or a curved surface, and the high-beam reflecting surface is a plane or a curved surface.

Further, the reflecting element is an integrally molded part.

Preferably, the low-beam reflecting surface of the reflecting element faces a light emergent surface of the low-beam collimating element, and the high-beam reflecting surface of the reflecting element faces a light emergent surface of the high-beam collimating element.

As a preferred specific embodiment, the low-beam collimating element is a collimator or a reflecting up with an ellipsoid surface, and the high-beam collimating element is a collimator or a reflecting cup with an ellipsoid surface.

More specifically, the low-beam optical component further includes a low-beam circuit board for installing the low-beam light source, the high-beam optical component further includes a high-beam circuit board for installing the high-beam light source, and each of the low-beam circuit board and the high-beam circuit board is provided with a heat radiating element such as a heat radiator.

Preferably, the headlamp module is a high-beam and low-beam integrated headlamp module. The headlamp module adopts the above reflection-type headlamp module in the first technical solution. The light-collimating element includes a low-beam collimating element and a high-beam collimating element; the light source includes a low-beam light source located at a first focus of the low-beam collimating element and a high-beam light source located at a first focus of the high-beam collimating element; the low-beam light source and the low-beam collimating element form a low-beam optical component; the high-beam light source and the high-beam collimating element form a high-beam optical component; the reflecting element includes a reflecting surface, the reflecting surface is a paraboloid reflecting surface or a paraboloid-like reflecting surface, and an end edge of the reflecting surface near the low-beam collimating element is provided with a cutoff line structure for forming the bright-dark cutoff line; the second focus of the low-beam collimating element coincides with the focus of the reflecting surface, and is located between the cutoff line structure and the low-beam collimating element. Emergent light of the low-beam optical component, after being converged to the second focus of the low-beam collimating element, is diverged into the reflecting surface, and is reflected by the reflecting surface to be directed to the lens, and is emitted by the lens to form a low-beam light pattern; and the second focus of the high-beam collimating element coincides with the focus of the lens, and is located at the cutoff line structure. Emergent light of the high-beam optical component, after being converged to the focus of the lens, is diverged into the lens, and is refracted by the lens to form a high-beam light pattern.

Further preferably, the low-beam optical component is disposed below the lens and the high-beam optical component, and the cutoff line structure is disposed at an end edge of a lower end portion of the reflecting surface.

Further preferably, the reflecting surface is a curved surface obtained by rotating a parabola or a parabola-like line around a central axis.

Further preferably, the low-beam collimating element and the high-beam collimating element are reflecting mirrors shaped as an ellipsoid surface or reflecting mirror shaped as an ellipsoid-like surface.

Further preferably, the light-collimating element includes a plurality of low-beam collimating elements arranged in a row with each other and a plurality of high-beam collimating elements arranged in a row with each other; the light source includes a plurality of low-beam light sources arranged in one-to-one correspondence with the low-beam collimating elements and a plurality of high-beam light sources arranged in one-to-one correspondence with the high-beam collimating elements; and the reflecting element includes a plurality of reflecting surfaces arranged in one-to-one correspondence with the low-beam collimating elements, and a cutoff line structure for forming a bright-dark cutoff line is provided at an end edge of each of the reflecting surfaces close to the low-beam collimating elements.

Further preferably, the lens is a bidirectional alignment lens, the bidirectional alignment lens includes a light incident portion making horizontal single-direction alignment (making alignment in a single horizontal direction) and a light emergent portion making vertical single-direction alignment (making alignment in a single vertical direction), and the light incident portion includes a plurality of light incident surfaces arranged in one-to-one correspondence with the reflecting surfaces.

Preferably, the reflection-type headlamp module is a high-beam and low-beam integrated headlamp module, and the headlamp module adopts the above reflection-type headlamp module in the first technical solution above. The light source includes a low-beam light source and a high-beam light source, the light-collimating element includes a low-beam reflecting cup and a high-beam reflecting cup, and the reflecting element includes a low-beam reflecting mirror and a high-beam reflecting mirror; the low-beam reflecting cup, the low-beam reflecting mirror, the high-beam reflecting cup and the high-beam reflecting mirror form a reflecting cup module, and the low-beam light source and the high-beam light source are located in the reflecting cup module; the lens is located in a light emergent direction of the reflecting cup module; the low-beam reflecting mirror is arranged on an edge of a light emergent opening in a light emergent direction of the low-beam reflecting cup so as to be suitable for reflecting the light emitted by the low-beam light source to the lens to form a low-beam light pattern; the high-beam reflecting mirror is arranged on an edge of a light emergent opening in a light emergent direction of the high-beam reflecting cup so as to be suitable for reflecting the light emitted by the high-beam light source to the lens to form a high-beam light pattern; and a side, far from a wall of the low-beam reflecting cup, of the low-beam reflecting mirror is connected with a side, far from a wall of the high-beam reflecting cup, of the high-beam reflecting mirror to form the modular reflecting cup module.

Further preferably, the low-beam reflecting cup, the low-beam reflecting mirror, the high-beam reflecting mirror and the high-beam reflecting cup are integrally molded to form the reflecting cup module. In the preferred technical solution, the reflecting cup module is integrally molded by the low-beam reflecting cup, the low-beam reflecting mirror, the high-beam reflecting cup and the high-beam reflecting mirror, and the low-beam reflecting cup, the low-beam reflecting mirror, the high-beam reflecting cup and the high-beam reflecting mirror are firm in connection and high in position relationship stability, so as to be incapable of displacement.

Preferably, the low-beam reflecting cup is shaped as an ellipsoid surface or an ellipsoid-like surface, a light emitter of the low-beam light source is located at a first focus of the low-beam reflecting cup, and the low-beam reflecting mirror is located at a second focus of the low-beam reflecting cup. The high-beam reflecting cup is shaped as an ellipsoid surface or an ellipsoid-like surface, a light emitter of the high-beam light source is located at a first focus of the high-beam reflecting cup, and the high-beam reflecting mirror is located at a second focus of the high-beam reflecting cup. In the preferred technical solution, the reflecting cup shaped as the ellipsoid surface is good in convergence performance due to the capability of better converging the light emitted by the light source located at the first focus to the second focus and convenient to machine. The ellipsoid-like surface is similar to the ellipsoid surface in shape, is formed by certain adaptive adjustment for light pattern optimization on the basis of the shape of the ellipsoid surface and is capable of intensifying or weakening the converged light on a specific part so that the formed light pattern better meets an illuminating requirement of a vehicle.

Further preferably, the cutoff line structure is formed on a junction of the low-beam reflecting mirror and the high-beam reflecting mirror and is located in a second focus region of the low-beam reflecting cup. According to the preferred technical solution, due to the formation of the cutoff line structure at the junction of the low-beam reflecting mirror and the high-beam reflecting mirror, a traditional reflecting cup is omitted, and the structure of the module is simplified. Meanwhile, the cutoff line forming structure is directly formed on the low-beam reflecting mirror and forms an integral structure with the low-beam reflecting mirror, so that the position stability of the cutoff line forming structure is higher. A bright-dark cutoff line of a low-beam light pattern formed by the cutoff line forming structure arranged in the second focus region of the low-beam reflecting cup is clearer.

Preferably, the reflecting surfaces of the low-beam reflecting mirror and/or the high-beam reflecting mirror are planes, curved surfaces or are composed of a plurality of planes and/or curved surfaces. In the preferred technical solution, the reflecting mirror with the reflecting surface being the plane is simple and convenient to machine, a light pattern formation way is simple, and the degree of reflected light restoring incident light is high. By using the reflecting mirror with the reflecting surface being the curved surface, light for forming the illuminating light pattern may be secondarily changed, and a specific part of the illuminating light pattern may be adjusted and optimized, so that the formed illuminating light pattern is more reasonable and better in illuminating effect. For a reflecting mirror composed of a plurality of planes and/or curved surfaces, each reflecting plane and/or curved surface of the reflecting mirror may be respectively designed, reflection directions of light irradiating to each part of the reflecting mirror is precisely adjusted, and the shape and brightness of the formed illuminating light pattern is controlled, so that the illuminating light pattern meets the design requirement, and the driving experience of a driver of a vehicle is effectively improved.

Preferably, the reflecting surface of each of the low-beam reflecting mirror and the high-beam reflecting mirror is provided with a highly reflective material layer. According to the preferred technical solution, by using the highly reflective material layer, a light reflecting effect of the reflecting mirror can be improved, a utilization ratio of the light emitted by the light source is increased, and the brightness of the illuminating light pattern is improved.

Further preferably, the highly reflective material layer is an aluminum-plated layer or a silver-plated layer. In the preferred technical solution, the aluminum-plated highly reflective material layer is relatively low in cost, but relatively poor in plating layer stability. The silver-plated highly reflective material layer is high in plating layer stability and good in reflecting effect, but relatively high in cost.

Preferably, the reflection-type headlamp module is a high-beam and low-beam integrated headlamp module. The reflection-type headlamp module adopts the reflection-type headlamp module in the first technical solution above. The reflection-type headlamp module further includes a light shielding plate; the light source includes a low-beam light source and a high-beam light source; the light-collimating element includes a low-beam collimating element and a high-beam collimating element, and the low-beam collimating element is suitable for converging the light emitted by the low-beam light source and projecting the light; the light shielding plate is arranged on a projection light path of the low-beam collimating element so as to perform low-beam distribution on the light emitted by the low-beam light source; the high-beam collimating element is suitable for converging the light emitted by the high-beam light source and projecting the light; and the reflecting element is a reflecting mirror arranged on projection light paths of the low-beam collimating element and the high-beam collimating element so as to reflect the light emitted by the low-beam light source and/or the high-beam light source to the lens, and the light is projected by the lens to form an illuminating light pattern.

Further preferably, the low-beam collimating element is a low-beam reflecting cup, the low-beam reflecting cup is shaped as a curved surface with a first focus and a second focus, the low-beam light source is located at the first focus of the low-beam reflecting cup, and the light shielding plate is located in a second focus region of the low-beam reflecting cup; and/or the high-beam collimating element is a high-beam reflecting cup, the high-beam reflecting cup is shaped as a curved surface with a first focus and a second focus, and the high-beam light source is located at the first focus of the high-beam reflecting cup. According to the preferred technical solution, the low-beam light source is arranged at the first focus located at a bottom of the low-beam reflecting cup, and thus, by using the low-beam reflecting cup, the light emitted by the low-beam light source can be converged to the second focus located near a light emergent opening of the low-beam reflecting cup and can be projected through the light emergent opening. Low-beam light is shielded by the light shielding plate located in the second focus region of the low-beam reflecting cup so as to finally form a clear low-beam light pattern provided with a bright-dark cutoff line. The high-beam light source is arranged on the first focus located at a bottom of the high-beam reflecting cup, and thus, by using the high-beam reflecting cup, the light emitted by the high-beam light source can be converged to the second focus located at a side where a light emergent opening of the high-beam reflecting cup is located and can be projected through the light emergent opening. Finally, the light is projected by the lens to form a high-beam light pattern.

Further, the low-beam reflecting cup is shaped as an ellipsoid surface or an ellipsoid-like surface, and/or the high-beam reflecting cup is shaped as an ellipsoid surface or an ellipsoid-like surface. In the preferred technical solution, the reflecting cup shaped as the ellipsoid surface is good in convergence performance due to the capability of better converging the light emitted by the light source located at the first focus to the second focus and convenient to machine. The ellipsoid-like surface is similar to the ellipsoid surface in shape, is formed by certain adaptive adjustment for light pattern optimization on the basis of the ellipsoid surface and is capable of locally adjusting the formed light pattern so as to ensure that the formed light pattern better meets an illuminating requirement of a vehicle.

Preferably, the high-beam and low-beam integrated headlamp module of the present disclosure further includes a PCB (printed circuit board), the low-beam light source and the high-beam light source are LED light sources, and the low-beam light source and the high-beam light source are respectively arranged on opposite surfaces of the PCB. According to the preferred technical solution, the low-beam light source and the high-beam light source are arranged on the opposite surfaces of the same PCB, so that an optical axis of the low-beam reflecting cup of the headlamp module is basically parallel to an optical axis of the high-beam reflecting cup of the headlamp module, the low-beam reflecting cup and the high-beam reflecting cup are more compact in structure, and the reflecting mirror is also simpler in arrangement.

Preferably, the lens includes a low-beam region and a high-beam region, and the low-beam region and the high-beam region have different foci; the second focus of the low-beam reflecting cup and a focus of the low-beam region are symmetrically arranged relative to the reflecting surface of the reflecting mirror, and the second focus of the high-beam reflecting cup and a focus of the high-beam region are symmetrically arranged relative to the reflecting surface of the reflecting mirror. In the preferred technical solution, light emitted from the second focus of the low-beam reflecting cup, after being reflected by the reflecting mirror, which is equivalent to that the light is emitted from the focus of the low-beam region, can be aligned by the low-beam region to form a clear low-beam light pattern. Light emitted from the second focus of the high-beam reflecting cup, after being reflected by the reflecting mirror, which is equivalent to that the light is emitted from the focus of the high-beam region, can be aligned by the high-beam region to form a clear high-beam light pattern. As the low-beam region and the high-beam region have different foci, the second focus of the low-beam reflecting cup and the second focus of the high-beam reflecting cup may also be arranged at different points, the light shielding plate located in the second focus region of the low-beam reflecting cup is prevented from affecting a high-beam light path, and thus, the high-beam light pattern is more uniform.

Preferably, the reflecting surface of the reflecting mirror is a plane or curved surface. In the preferred technical solution, the reflecting mirror with the reflecting surface being the plane is simple and convenient to machine, reflected light basically follows an original light distribution mode, and a light pattern formation way is simpler. By using the reflecting mirror with the reflecting surface being the curved surface, a specific part of the illuminating light pattern can be adjusted and optimized, so that the formed illuminating light pattern is more reasonable and the illuminating effect is better.

In a third aspect, the present disclosure provides a headlamp including the reflection-type headlamp module provided according to the first aspect of the present disclosure or the headlamp module provided according to the second aspect of the present disclosure.

In a fourth aspect, the present disclosure provides a vehicle including the headlamp provided according to the third aspect of the present disclosure.

According to the above technical solutions, in the reflection-type headlamp module of the present disclosure, the light emitted from the light-collimating element irradiates to the lens after being reflected by the reflecting element to form the illuminating light pattern. The reflecting mirror changes the irradiation direction of the light, so that the light emergent direction of the light-collimating element and the optical axis of the lens are not arranged on the same straight line, then the length of the headlamp module in the front and rear direction can be effectively reduced. The focus of the lens is arranged at a mirror point of the second focus of the reflecting cup relative to the reflecting surface of the reflecting mirror, so that the illuminating light pattern of the headlamp module is highly clear. Due to the adoption of the reflecting surfaces, with different shapes, of the reflecting mirror, the illuminating light pattern formed by the headlamp module can be adjusted, so that the illuminating light pattern is optimized, and the illuminating effect is improved. For the reflection-type headlamp module for low-beam illumination, a light shielding plate structure is replaced with the reflecting element, and the reflecting element is provided with the cutoff line structure capable forming the bright-dark cutoff line, so that the structure of the module is simplified, and the stability of the module is improved. Due to the integrally molded structure of the reflecting mirror and the reflecting cup, the reflecting mirror and the reflecting cup are firmer in connection and higher in connection stability.

The headlamp module with the high-beam function and the low-beam function of the present disclosure includes the low-beam optical component, the high-beam optical component, the reflecting structure and the lens. By adjusting the light emergent direction of the low-beam optical component, the light emergent direction of the high-beam optical component, as well as the included angles between the low-beam reflecting surface and the high-beam reflecting surface of the reflecting structure, the low-beam reflecting surface of the reflecting structure is located on an emergent light path of the low-beam optical component, and the high-beam reflecting surface of the reflecting structure is located on an emergent light path of the high-beam optical component. When the low-beam optical component is started alone, emergent light of the low-beam optical component is emitted to the low-beam reflecting surface, is reflected to a light incident surface of the lens by the low-beam reflecting surface after being shielded by a cutoff part and is refracted by the lens to form a low-beam light pattern. When the high-beam optical component is started alone, emergent light of the high-beam optical component is emitted to the high-beam reflecting surface, a part of light is directly emitted to the light incident surface of the lens, the other part of light is emitted to the high-beam reflecting surface and is emitted to the light incident surface of the lens after being reflected by the high-beam reflecting surface, and the two parts of light are superposed after being refracted by the lens to form a high-beam light pattern. In this way, by using the headlamp module of the present disclosure, the high-beam light pattern and the low-beam light pattern can be conveniently and rapidly switched without noise, and the irradiation angle of high-beam light may be increased so that a region close to a vehicle is prevented from being excessively bright. According to the high-beam and low-beam integrated headlamp module of the present disclosure, the low-beam reflecting cup, the low-beam reflecting mirror, the high-beam reflecting cup and the high-beam reflecting mirror are connected to form one module by adopting the modular reflecting cup module, so that the low-beam reflecting cup, the low-beam reflecting mirror, the high-beam reflecting cup and the high-beam reflecting mirror are in a fixed position relationship, a light adjusting process of the headlamp module is simplified, and the formed illuminating light pattern is high in stability and not easy to deform. Due to the arrangement of the reflecting mirror in the headlamp module, propagation directions of the low-beam light and the high-beam light are changed, and the length of the headlamp module in the front and rear direction is reduced. Due to the arrangement of the cutoff line forming structure at the edge of the low-beam reflecting mirror, a traditional light barrier is omitted, the structure of the headlamp module is simplified, there are no mutual influences between a low-beam light pattern formation light path and a high-beam light pattern formation light path, the light barrier in a working state is prevented from shielding the high-beam light when the low-beam light source and the high-beam light source work at the same time, and the illuminating effect is improved. Due to the arrangement of the different foci in the low-beam region and the high-beam region of the lens, the light shielding plate located in the second focus region of the low-beam reflecting cup is separated from the second focus of the high-beam reflecting cup, so that influences of the light shielding plate to the high-beam light path are avoided.

The headlamp of the present disclosure is small in front and rear diameter of a lamp body, occupies smaller space, clear in light pattern and high in light pattern stability. The vehicle of the present disclosure using the headlamp of the present disclosure also has the above advantages.

### BRIEF DESCRIPTION OF DRAWINGS

FIG. 1 is a schematic structural diagram of a traditional headlamp module;

FIG. 2 is a front schematic diagram showing an embodiment of a headlamp module according to the present disclosure;

FIG. 3 is a side schematic diagram showing an embodiment of the headlamp module according to the present disclosure;

FIG. 4 is a schematic structural diagram showing a section of an A-A position in FIG. 2;

FIG. 5 is a schematic diagram showing an illuminating light path in an embodiment of the headlamp module according to the present disclosure;

FIG. 6 is a schematic diagram showing a focus position of the illuminating light path in FIG. 5;

FIG. 7 is a schematic diagram showing a position relationship between components in an embodiment of the headlamp module according to the present disclosure;

FIG. 8 is a schematic diagram showing an illuminating light path in FIG. 7;

FIG. 9 is a schematic diagram showing (low-beam light) screen illuminance in an embodiment of the headlamp module according to the present disclosure;

FIG. 10 is a schematic diagram showing (high-beam light) screen illuminance in an embodiment of the headlamp module according to the present disclosure;

FIG. 11 is a schematic diagram showing a contour structure in a specific embodiment of a low-beam reflection-type headlamp module according to the present disclosure;

FIG. 12 is a schematic diagram showing light in a specific embodiment of the low-beam reflection-type headlamp module according to the present disclosure;

FIG. 13 is a schematic structural diagram showing a specific embodiment of a reflecting element in the low-beam reflection-type headlamp module according to the present disclosure;

FIG. 14 is a schematic structural diagram showing another specific embodiment of the reflecting element in the low-beam reflection-type headlamp module according to the present disclosure;

FIG. 15 is a side schematic diagram showing an embodiment of a headlamp module according to the present disclosure;

FIG. 16 is a front schematic diagram showing an embodiment of the headlamp module according to the present disclosure;

FIG. 17 is a schematic structural diagram showing a section in an embodiment of the headlamp module according to the present disclosure;

FIG. 18 is a schematic diagram showing a light path in an embodiment of the headlamp module according to the present disclosure;

FIG. 19 is a schematic structural diagram showing a specific embodiment of the headlamp module according to the present disclosure;

FIG. 20 is a schematic diagram showing a low-beam light path in a specific embodiment of the headlamp module according to the present disclosure;

FIG. 21 is a schematic diagram showing a high-beam light path in a specific embodiment of the headlamp module according to the present disclosure;

FIG. 22 is a schematic structural diagram showing a specific embodiment of a reflecting structure according to the present disclosure;

FIG. 23 is a schematic diagram showing a low-beam light pattern in a specific embodiment of the headlamp module according to the present disclosure;

FIG. 24 is a schematic diagram showing a high-beam light pattern in a specific embodiment of the headlamp module according to the present disclosure;

FIG. 25 is a schematic diagram showing a first illuminating light pattern of the headlamp module according to the present disclosure;

FIG. 26 is a schematic diagram showing a second illuminating light pattern of the headlamp module according to the present disclosure;

FIG. 27 is a schematic perspective diagram of a specific embodiment of the headlamp module according to the present disclosure;

FIG. 28 is a schematic diagram of a low-beam light path in a specific embodiment of the headlamp module according to the present disclosure;

FIG. 29 is a schematic perspective diagram of a low-beam light path in a specific embodiment of the headlamp module according to the present disclosure;

FIG. 30 is a schematic diagram of a high-beam light path in a specific embodiment of the headlamp module according to the present disclosure;

FIG. 31 is a schematic perspective diagram of a high-beam light path in a specific embodiment of the headlamp module according to the present disclosure;

FIG. 32 is a front schematic diagram of an embodiment of the headlamp module according to the present disclosure;

FIG. 33 is a side schematic diagram of an embodiment of the headlamp module according to the present disclosure;

FIG. 34 is a schematic diagram showing a section of a B-B position in FIG. 27;

FIG. 35 is a schematic diagram showing a low-beam light path in an embodiment of the headlamp module according to the present disclosure;

FIG. 36 is a schematic diagram showing a high-beam light path in an embodiment of the headlamp module according to the present disclosure;

FIG. 37 is a diagram showing screen illuminance of a low-beam light pattern of the headlamp module according to the present disclosure;

FIG. 38 is a diagram showing screen illuminance of a high-beam light pattern of the headlamp module according to the present disclosure;

FIG. 39 is a diagram showing screen illuminance of a superposed high-beam and low-beam light pattern of the headlamp module according to the present disclosure;

FIG. 40 is a schematic structural diagram showing an embodiment of a high-beam and low-beam integrated headlamp module according to the present disclosure;

FIG. 41 is a schematic diagram showing a low-beam light path in an embodiment of the high-beam and low-beam integrated headlamp module according to the present disclosure;

FIG. 42 is a schematic diagram showing a high-beam light path in an embodiment of the high-beam and low-beam integrated headlamp module according to the present disclosure; and

FIG. 43 is a schematic diagram showing a focus position in an embodiment of the high-beam and low-beam integrated headlamp module according to the present disclosure.

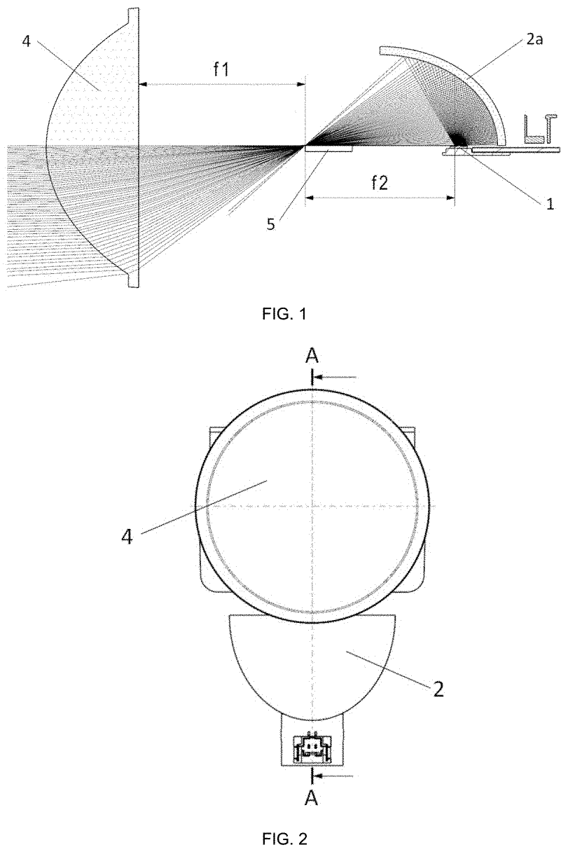

Description of the reference signs in the drawings

| | | | |
|---|---|---|---|
| 1 | light source | 11 | low-beam light source |
| 12 | high-beam light source | 2 | light-collimating element |
| 21 | low-beam collimating | 22 | high-beam collimating |
| | element | | element |
| 2a | reflecting cup | 21a | low-beam reflecting cup |
| 21f | low-beam second focus | 22a | high-beam reflecting cup |
| | position | | |
| 22f | high-beam second focus | 2m | reflecting cup module |
| | position | | |
| 3 | reflecting element | 31 | low-beam reflecting |
| | | | mirror |
| 30 | reflecting surface | 30a | end edge |
| 32 | high-beam reflecting | 31a | low-beam reflecting |
| | mirror | | surface |
| 32a | high-beam reflecting | 4 | lens |
| | surface | | |
| 41 | low-beam region | 42 | high-beam region |
| 43 | lens holder | 5 | light shielding plate |
| 6 | cutoff line structure | 7 | PCB |
| 71 | low-beam circuit board | 72 | high-beam circuit |
| | | | board |
| 8 | heat radiator | | |
| F | focus position | F′ | focus mirror position |
| F1 | focus of low-beam | F2 | focus of high-beam |
| | region | | region |

### DETAILED DESCRIPTION OF EMBODIMENTS

In the present disclosure, a location or position relationship indicated by used location words such as “front”, “rear”, “upper” and “lower” is based on a location or position relationship of a headlamp module or a headlamp, normally installed on a vehicle, of the present disclosure in the case that there is no opposite description, wherein a normal running direction of the vehicle is “front”, and a direction opposite to the normal running direction is “rear”.

Specific embodiments of the present disclosure are described in detail below in conjunction with the accompanying drawings. It should be understood that the specific embodiments described herein are merely intended to describe and explain the present disclosure, and the scope of protection of the present disclosure is not limited to the following specific embodiments.

In the description of the present disclosure, it should be explained that a location or position relationship indicated by a term such as “low-beam light propagation path” is based on a location or position relationship shown in the accompanying drawings and is merely a simplified description for facilitating the description of the present disclosure, and the low-beam light propagation path in the present disclosure refers to a light path in a main transmission direction of light converged by a light-collimating element or light reflected by a reflecting mirror. A location or position relationship indicated by a term such as “emergent light path” is based on a location or position relationship shown in the accompanying drawings and is merely a simplified description for facilitating the description of the present disclosure, and the emergent light path in the present disclosure refers to a light path in a main transmission direction of the light converged by the reflecting element, a low-beam optical component or a high-beam optical component.

In the description of the present disclosure, it should be noted that “cutoff line structure” is a general term in the art, and the cutoff line structure is an upper boundary, having a vertical difference at left and right and an inflection point, of a light pattern and is obliquely upwards connected with a boundary located above after passing through the inflection point.

In the description of the present disclosure, it should be further noted that terms “installation”, “connection” and “contact” should be understood in a broad sense unless otherwise specified and defined, for example, “connection” may be fixed connection or detachable connection or integrated connection, may be direct connection or indirect connection through an intermediate medium, and may be internal connection of two elements or interaction between two elements. Those of ordinary skill in the art may understand specific meanings of the above terms in the present disclosure according to specific situations.

As shown in FIG. 2 to FIG. 4, in an embodiment, a reflection-type headlamp module of the present disclosure includes a light source 1, a light-collimating element 2, a reflecting element 3 and a lens 4. The light-collimating element 2 is capable of gathering divergent light emitted by the light source 1 and projecting the light to a specific direction. A reflecting cup 2a, a collimator or any other optical element meeting a requirement may be selected as the light-collimating element 2. The light source 1 may be arranged at different relative positions of the light-collimating element 2 according to the selected different light-collimating element 2. For example, when the reflecting cup 2a is selected as the light-collimating element, the light source 1 is arranged at a focus located at a bottom of the reflecting cup 2a; and when the collimator is selected as the light-collimating element, the light source 1 is arranged at a light incident opening of the collimator. The light source 1 needs to be arranged at a position beneficial to the gathering and emission of light emitted by the light source 1. A reflecting mirror may be selected as the reflecting element 3. The reflecting element 3 is arranged on an emergent light path of the light-collimating element 2 and is capable of reflecting the light emitted by the light source 1 and gathered by the light-collimating element 2 to the lens 4 by changing an original irradiation direction of the light, and the light may be projected by the lens 4 to form an illuminating light pattern. Due to the change of the light irradiation direction, a direction in which the light emitted from the light-collimating element 2 and a direction in which the light enters the lens 4 are not restricted on the same straight line, so that the arrangement positions of the light-collimating element 2 and the lens 4 are changed, and the front and rear length of the headlamp module is effectively reduced.

In some embodiments of the reflection-type headlamp module of the present disclosure, the reflecting mirror is selected as the reflecting element 3, and the reflecting cup 2a is selected as the light-collimating element 2. A reflecting surface of the reflecting mirror is a plane. The reflecting surface which is the plane is capable of reflecting light emitted from a light emergent opening of the reflecting cup 2a to the lens 4 as it is, which is the same as that the lens 4 is directly arranged in a light emergent direction of the reflecting cup 2a. In some other embodiments, the reflecting mirror is selected as the reflecting element 3, and the reflecting cup 2a is selected as the light-collimating element 2. The reflecting surface of the reflecting mirror is a curved surface. By using the reflecting surface which is the curved surface, a light pattern formed by the light emitted from the light emergent opening of the reflecting cup 2a may be secondarily changed, so that the light pattern formed by the headlamp module may be more flexibly designed.

In some embodiments of the reflection-type headlamp module of the present disclosure, the reflecting surface of the reflecting mirror is provided with a highly reflective material layer. A highly reflective material is capable of reflecting more incident light due to relatively high reflectivity, and thus, loss of light is reduced. An existing highly reflective material is mainly a metal material, and the metal material is relatively convenient to machine.

In some embodiments of the reflection-type headlamp module of the present disclosure, the highly reflective material layer on the reflecting surface of the reflecting mirror is an aluminum-plated layer or a silver-plated layer. The aluminum-plated layer may achieve the reflectivity of 85-90% and is good in reflecting performance and low in price. The silver-plated layer may achieve the reflectivity of 95% and is excellent in reflecting performance, extremely high in plating layer stability and long in service life.

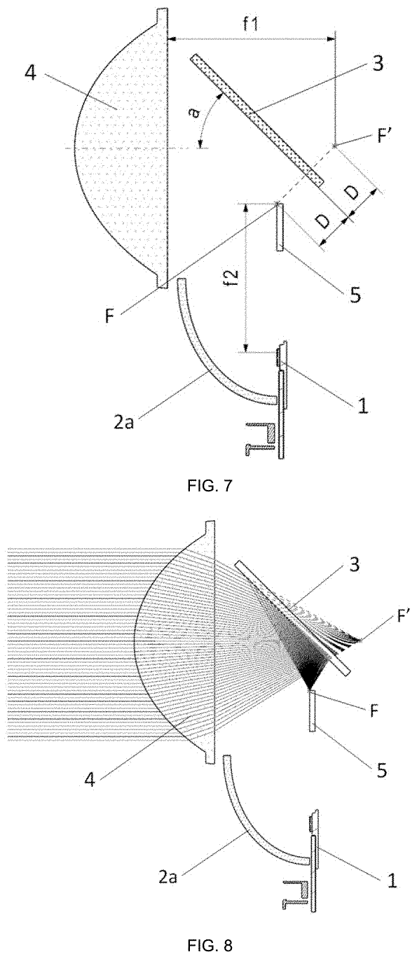

In some embodiments of the reflection-type headlamp module of the present disclosure, as shown in FIG. 7, an included angle between the reflecting surface of the reflecting mirror and an optical axis of the lens 4 is a, and the included angle α may be adjusted. An adjusting structure may adopt a mechanical adjusting device or an electrically-controlled adjusting device. The adjustment may be realized by those skilled in the art by adopting various conventional means, which is not described in detail herein. A height of the illuminating light pattern of the headlamp module may be adjusted by adjusting the included angle α. For example, when a low-beam light pattern is required to be formed, the included angle α may be appropriately reduced, so that the position of the light pattern may be lowered, and an irradiation distance of the light pattern may be shortened; and when a high-beam light pattern is required to be formed, the included angle α may be appropriately increased, so that the position of the light pattern may be heightened, and an irradiation distance of the light pattern may be increased.

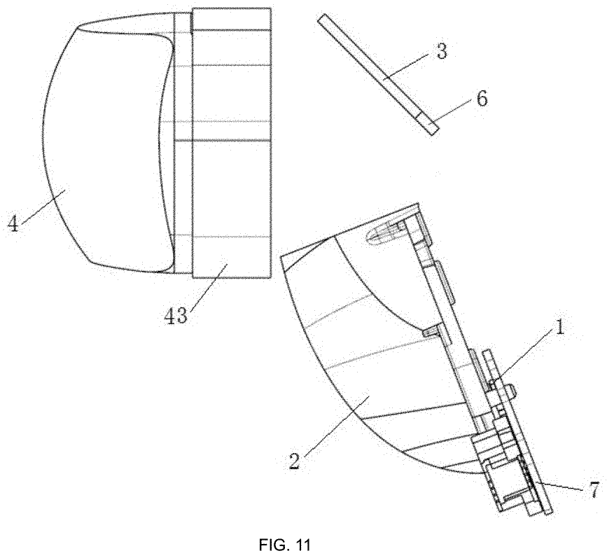

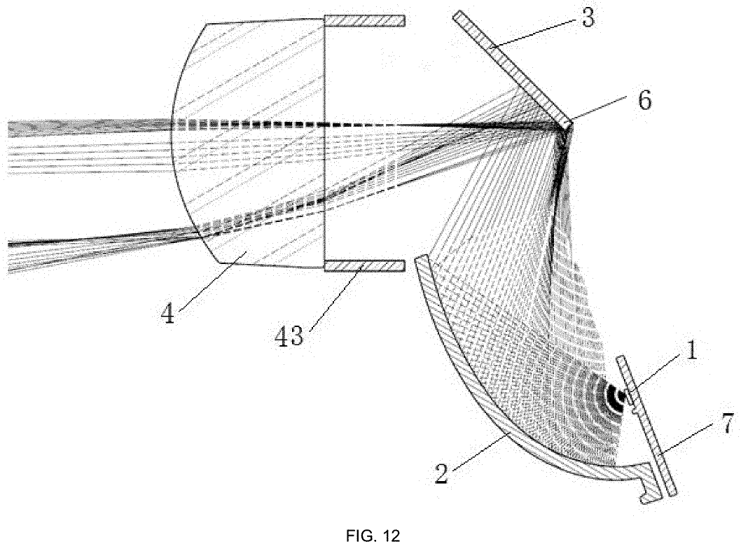

As shown in FIG. 11 and FIG. 12, in an embodiment of a low-beam reflection-type headlamp module of the present disclosure, a low-beam light propagation path is formed in the low-beam reflection-type headlamp module and a light source 1, a light-collimating element 2, a reflecting element 3 and a lens 4 are sequentially provided in the low-beam light propagation path. The reflecting element 3 is provided with a cutoff line structure 6 for forming a bright-dark cutoff line, and light of the light source 1 is suitable for being converged to the reflecting element 3 by the light-collimating element 2, is reflected to the lens 4 by the reflecting element 3 and is projected by the lens 4 to form an illuminating low-beam light pattern.

As shown in FIG. 12 which is a schematic structural diagram showing light distribution of the low-beam reflection-type headlamp module of the present disclosure, the light-collimating element 2 is capable of converging divergent light emitted by the light source 1 and projecting the converged light towards a specific direction, while the light source 1 may be arranged at different relative positions according to the selected different light-collimating element 2. If a reflecting cup 2a is selected as the light-collimating element 2, and the light source 1 is arranged at a focus located at a bottom of the reflecting cup; and if a collimator is selected as the light-collimating element 2, the light source 1 is arranged at a light incident opening of the collimator. The light source 1 is arranged at a position beneficial to the gathering and emission of light emitted by the low-beam light source 1. The reflecting element 3 is arranged on an emergent light path of the light-collimating element 2 and is capable of reflecting the light emitted by the light source 1 and converged by the light-collimating element 2 to the lens 4 by changing an original irradiation direction, and the light may be projected by the lens 4 to form the illuminating low-beam light pattern.

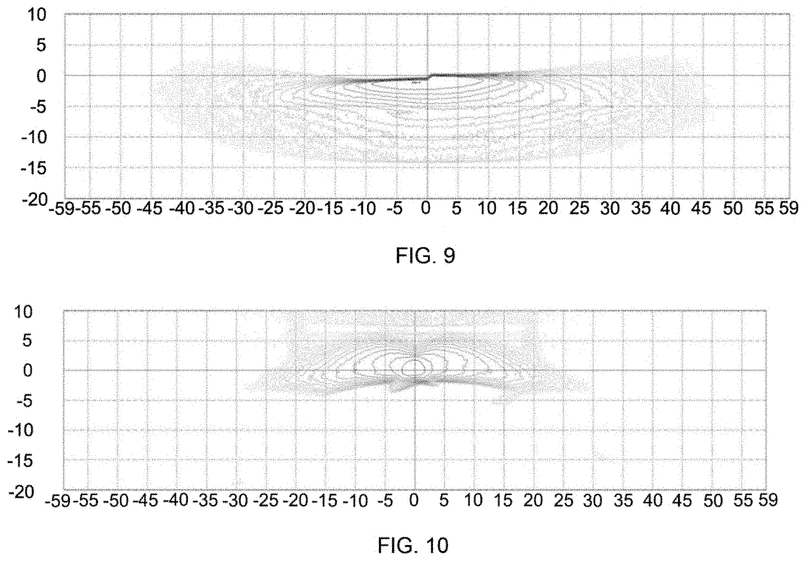

FIG. 9 is a schematic diagram showing low-beam light screen illuminance of the low-beam reflection-type headlamp module of the present disclosure. It can be seen from FIG. 9 that light emitted from the low-beam reflection-type headlamp module of the present disclosure completely meets requirements on regulatory illuminance through detection. Moreover, as a propagation direction of low-beam light in the headlamp module is changed, a low-beam light propagation direction is not restricted to a straight line direction, so that front and back position of the light-collimating element 2 and the lens 4 can be changed. Furthermore, the front and rear length of the headlamp module is effectively reduced, and an internal space position of the low-beam reflection-type headlamp module of the present disclosure is arranged more flexibly and also more reasonably.

An installation position and angle of the reflecting element 3 in the low-beam reflection-type headlamp module of the present disclosure may be set according to a size of a space in the headlamp module, and then, positions of the light source 1 and the light-collimating element 2 may be arranged according to the position and angle of the reflecting element 3, so that the illuminating low-beam light pattern can be formed, in this way, a space structure in the headlamp module may be flexibly arranged, so that the space layout for the headlamp module is more flexible.

As a preferred embodiment of the present disclosure, a reflecting surface of the reflecting element 3 is located on the emergent light path of the light-collimating element 2, and the cutoff line structure 6 is arranged at an edge of an end, close to the light-collimating element 2, of the reflecting surface.

The reflecting surface of the reflecting element 3 in the low-beam reflection-type headlamp module of the present disclosure is located below the reflecting element 3 so that the light reflected after being converged by the light-collimating element 2 can be projected to the lens 4 after passing through the reflecting surface. By arranging the cutoff line structure 6 at the edge of the end, close to the light-collimating element 2, of the reflecting surface, illuminating low-beam light with a low-beam cutoff line can be better formed, such that an illuminating requirement is met, and the formed light meets regulatory requirements.

Herein, the reflecting surface in the present disclosure may be further additionally provided with an aluminum-plated layer or a silver-plated layer for increasing the reflectivity of the light. Through detection, the aluminum-plated layer may achieve the reflectivity of 85%-90% and is good in reflecting performance and low in price. The silver-plated layer may achieve the reflectivity of 95% and is excellent in reflecting performance, extremely high in plating layer stability and long in service life.

As a preferred embodiment of the present disclosure, the light-collimating element 2 is a reflecting cup 2a, and the reflecting cup 2a is shaped as a curved surface with a first focus and a second focus.

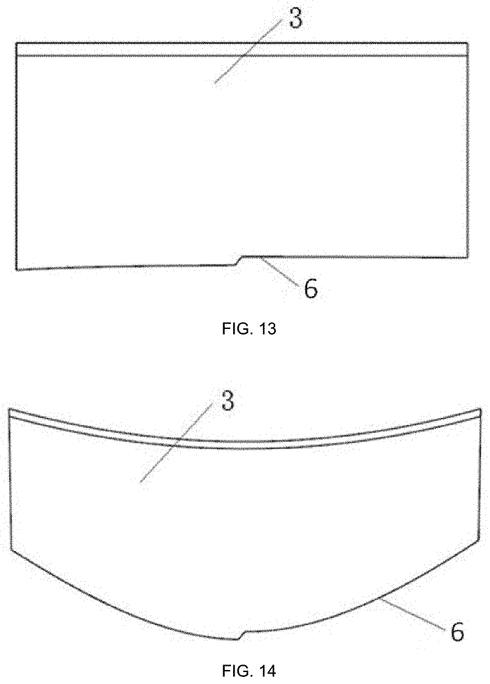

As shown in FIG. 13 and FIG. 14, as a further preferred embodiment of the present disclosure, the reflecting element 3 is a reflecting mirror. Moreover, the reflecting mirror is a planar reflecting mirror or a curved-surface reflecting mirror.

The reflecting mirror as shown in FIG. 13 is a planar reflecting mirror, the reflecting mirror as shown in FIG. 14 is a curved-surface reflecting mirror, and the two structures are relatively simple and beneficial to the arrangement of the cutoff line structure 6 as well as the determination and adjustment of the installation position and angle of the reflecting element 3. However, the reflecting mirror is not structurally restricted to the planar reflecting mirror or the curved-surface reflecting mirror, and the reflecting mirror may also be a paraboloid-like reflecting mirror or a free-curved-surface reflecting mirror and the like for forming light with higher requirements.

As a further preferred embodiment of the present disclosure, the light source 1 is located at the first focus, and the cutoff line structure 6 is located at the second focus.

The light-collimating element 2 may be the reflecting cup 2a, the light source 1 is located at the first focus of the reflecting cup 2a, and the cutoff line structure 6 is located at the second focus of the reflecting cup 2a. With such arrangement, light emitted by the light source 1 may be better projected to the cutoff line structure 6 after being converged by the light-collimating element 2, so that a cutoff line in the illuminating low-beam light is more obvious and clearer.

A cup body of the reflecting cup 2a may be shaped as a sectioned ellipsoid surface or paraboloid, namely a shape formed by sectioning an ellipsoid surface or a paraboloid in a direction parallel to a long axis, and then, sectioning the obtained partial ellipsoid surface or paraboloid in a direction parallel to a short axis. However, the position of the above section is not restricted in the present disclosure, and even sectioning in the direction parallel to the long axis may be omitted, so that different requirements on the light source are met, and the light emergent opening of the reflecting cup is formed by a sectioned notch in the direction parallel to the short axis.

As another preferred embodiment of the present disclosure, the reflecting cup 2a is shaped as an ellipsoid surface or a paraboloid. The reflecting cup 2a shaped as the ellipsoid surface can uniformly converge the light emitted by the light source 1 located at the first focus to the second focus, so that the formed light pattern is more regular. The reflecting cup 2a shaped as the ellipsoid-like surface is obtained by adaptively adjusting the ellipsoid surface, so that reflection directions of part of light are changed purposely, and finally, the brightness of the part of light forming the illuminating light pattern is changed. In addition to the ellipsoid-shaped and the paraboloid-shaped reflecting cup 2a, the reflecting cup 2a in an ellipsoid-like shape or a paraboloid-like shape is also feasible. Meanwhile, some accessory structures may be additionally arranged on the basis of the ellipsoid surface, so that the formed light pattern better meets an illuminating requirement of a vehicle.

It should be noted that, in the context of the present disclosure, when the term “ellipsoid-like surface” is used, it should be understood that its surface type is close to that of an ellipsoid surface and has similar optical characteristics to that of an ellipsoid surface. Similarly, when the term “paraboloid-like surface” is used, it should be understood that its surface type is close to that of a paraboloid and has similar optical characteristics to that of the paraboloid. For example, similar to a paraboloid-shaped reflecting surface, when a paraboloid-like surface is used as the reflecting surface, light emitted from a light source located at or near a focus of the paraboloid-like surface, after being reflected by the paraboloid-like surface, can exit in a substantially parallel manner.

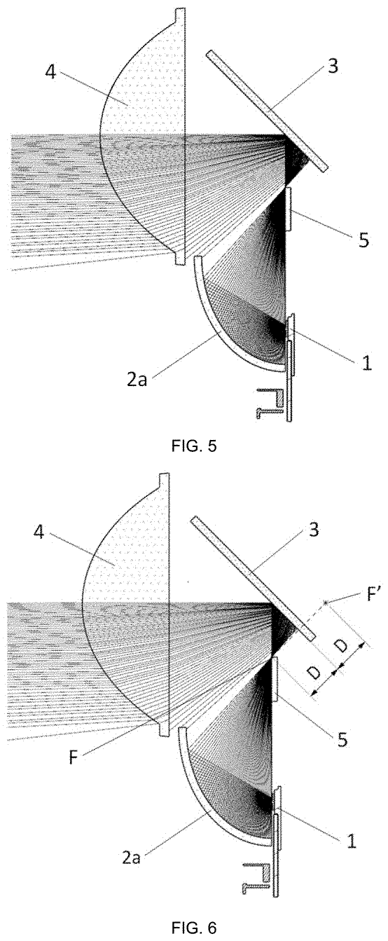

As shown in FIG. 2 to FIG. 5, in some embodiments of the reflection-type headlamp module of the present disclosure, the light-collimating element 2 adopts a reflecting cup 2a. The reflecting cup 2a is shaped as a curved surface with a first focus and a second focus, and generally, positions of the first focus and the second focus on the curved surface are symmetrical relative to a center of the curved surface. A light emergent opening of the reflecting cup 2a is formed in an end where the second focus of the reflecting cup 2a is located, that is, a focus located on an end where the light emergent opening is located is the second focus, and a focus located on an end opposite to the light emergent opening is the first focus. The light source 1 is located at the first focus of the reflecting cup 2a, the light emitted by the light source 1 can be converged to a direction of the second focus of the reflecting cup 2a after being reflected by the reflecting cup 2a, can be emitted from the light emergent opening of the reflecting cup 2a and can further irradiate forwards in a straight line direction. The reflecting mirror is arranged on the emergent light path of the reflecting cup 2a, when irradiating to the reflecting mirror, light emitted from the light emergent opening of the reflecting cup 2a is emitted to the lens 4 by changing an original irradiation direction under the reflecting action of the reflecting mirror and is projected by the lens 4 to form an illuminating light pattern.

As shown in FIG. 4, in some embodiments of the reflection-type headlamp module of the present disclosure, an included angle between an optical axis, formed by a connecting line of the first focus and the second focus of the reflecting cup 2a, of the reflecting cup 2a and an optical axis of the lens 4 is 60-120°. Since light of the headlamp module is finally projected to the front by the lens 4 to form an illuminating light pattern, a direction of the optical axis of the lens 4 is basically the front and rear direction of the headlamp module. When the included angle between the optical axis of the reflecting cup 2a and the optical axis of the lens 4 is relatively large, a length of the headlamp module in the front and rear direction is relatively long; and when the included angle between the optical axis of the reflecting cup 2a and the optical axis of the lens 4 is relatively small, mutual interference between the reflecting cup 2a and the lens 4 may happen easily, and thus, a layout position is affected. An appropriate included angle may ensure reasonable positions where the reflecting cup 2a and the lens 4 are arranged while reducing the front and rear length of the headlamp module.

As shown in FIG. 4, as an embodiment of the reflection-type headlamp module of the present disclosure, the included angle between the optical axis of the reflecting cup 2a and the optical axis of the lens 4 is 90°. In this case, the optical axis of the reflecting cup 2a is perpendicular to the optical axis of the lens 4, there is no interference between positions of the reflecting cup 2a and the lens 4, and in this case, the front and rear length of the headlamp module is mainly restricted by the focus of the lens 4 so as to make the front and rear length of the module smaller.

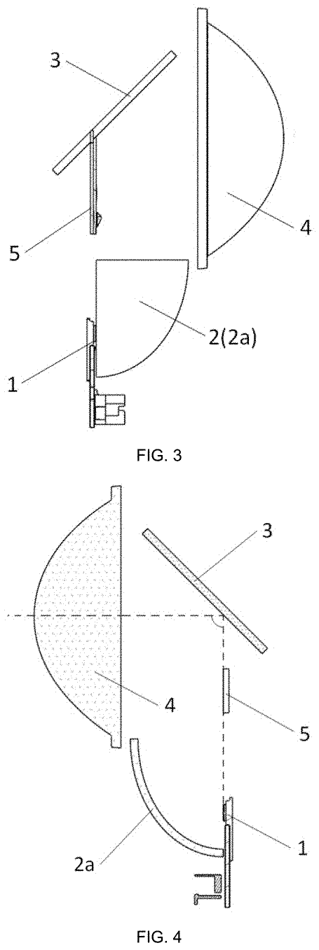

In some embodiments of the reflection-type headlamp module of the present disclosure, as shown in FIG. 3 and FIG. 4, the reflecting cup 2a is shaped as an ellipsoid surface, and in some other embodiments, the reflecting cup 2a is shaped as an ellipsoid-like surface. Specifically, a cup body of the reflecting cup 2a may be shaped as a sectioned ellipsoid surface or an ellipsoid-like surface, namely a shape formed by sectioning an ellipsoid surface or an ellipsoid-like surface in a direction parallel to a long axis, and then, sectioning the obtained partial ellipsoid surface or ellipsoid-like surface in a direction parallel to a short axis. The light source 1 is arranged at the first focus of the reflecting cup 2a. The position of the above section is not restricted in the present disclosure, and even, sectioning in the direction parallel to the long axis may be omitted, so that different requirements on the light source are met. A light emergent opening of the reflecting cup 2 is formed by a sectioned notch in the direction parallel to the short axis. The ellipsoid-shaped reflecting cup 2a can uniformly converge the light emitted by the light source 1 located at the first focus to the second focus, so that the formed light pattern is more regular. The reflecting cup 2a shaped as the ellipsoid-like surface is obtained by adaptively adjusting the ellipsoid surface, so that reflection directions of part of light are changed purposely, and finally, the brightness of the part of light in the illuminating light pattern is changed. Some accessory structures may be additionally arranged on the basis of the ellipsoid surface, so that the formed light pattern better meets an illuminating requirement of a vehicle.

In some embodiments of the reflection-type headlamp module of the present disclosure, as shown in FIG. 3 and FIG. 4, the reflection-type headlamp module of the present disclosure further includes a light shielding plate 5. The light shielding plate 5 is provided with a cutoff line structure for partially shielding light emitted from the light emergent opening of the reflecting cup 2a to form a bright-dark cutoff line of the illuminating light pattern. The cutoff line structure is located at the second focus of the reflecting cup 2a, so that the bright-dark cutoff line of the illuminating light pattern is clearer. The headlamp module provided with the light shielding plate 5 may be used as a low beam module due to the capability of forming a low-beam light pattern with a bright-dark cutoff line, as shown in FIG. 9, and a headlamp module without the light shielding plate 5 may be used as a high-beam module due to the capability of forming a high-beam light pattern without the bright-dark cutoff line, as shown in FIG. 10. The light shielding plate 5 may be set to be of a movable structure. When the low-beam light pattern is required to be formed, the light shielding plate 5 moves to the second focus of the reflecting cup 2a to shield light emitted from the light emergent opening of the reflecting cup 2a so that the low-beam light pattern with the bright-dark cutoff line is formed. When the high-beam light pattern is required to be formed, the light shielding plate 5 is moved away from the second focus of the reflecting cup 2a, and light emitted from the light emergent opening of the reflecting cup 2a is reflected to the lens 4 without shielding to form the high-beam light pattern.

As an embodiment of the reflection-type headlamp module of the present disclosure, as shown in FIG. 6 to FIG. 8, the second focus of the reflecting cup 2a is located at a focus position F where a mirror point, namely a focus mirror position F′, is formed relative to the reflecting surface of the reflecting mirror. That is, a connecting line of the focus position F and the focus mirror position F′ is perpendicular to a mirror surface, and a distance from the focus position F to the mirror surface and a distance from the focus mirror position F′ to the mirror surface are both D. The focus of the lens 4 is arranged at the focus mirror position F′. The light emitted by the light source 1 is reflected by the reflecting cup 2a so as to be converged to the second focus of the reflecting cup, namely the focus position F. Then, the light irradiates from the focus position F to the reflecting mirror and is emitted to the lens 4 under the reflecting action of the reflecting mirror. As shown in FIG. 8, the light emitted to the lens 4 is equivalent to the light emitted from the focus mirror position F′ and directly emitted to the lens 4.

As shown in FIG. 7, the front and rear length of the reflection-type headlamp module of the present disclosure is mainly restricted by a focal length f1 of the lens 4, and the front and rear length of the reflection-type headlamp module is not restricted by a distance f2 from the first focus to the second focus of the reflecting cup 2a. Moreover, the focus of the lens 4 is arranged at the focus mirror position F′ located behind the reflecting mirror, so that the front and rear length of the headlamp module can be further reduced.

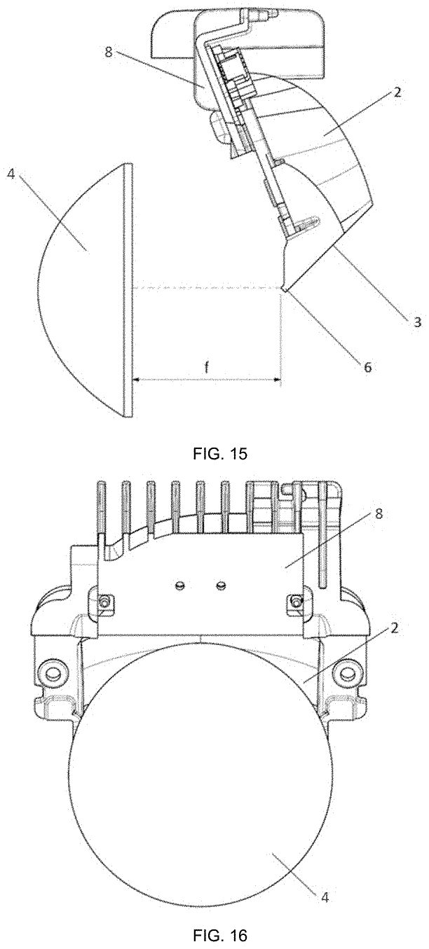

As shown in FIG. 15 to FIG. 17, in an embodiment, the reflection-type headlamp module of the present disclosure includes a light source 1, a reflecting cup 2a, a reflecting element 3 and a lens 4. The reflecting cup 2a is shaped as a curved surface with a first focus and a second focus. The reflecting cup 2a is provided with a light emergent opening for emitting light, the first focus of the reflecting cup 2a is located in a cup body, and the second focus of the reflecting cup is located outside the light emergent opening. The light source 1 is arranged at the first focus of the reflecting cup 2a. The light source 1 may adopt an LED light source, or a laser light source, or a halogen lamp light source or any other light sources suitable for being used in a vehicle lamp. When the light source such as the LED light source that requires heat dissipation is used, a heat radiator 8 may be further arranged to dissipate heat of the light source. By using the heat radiator 8, the temperature of the light source can be reduced, and the power and light emitting efficiency of the adopted light source can be increased. The reflecting element 3 is a reflecting mirror, one side (for example, preferably, an edge of one side) of the reflecting mirror is arranged on an edge of the light emergent opening in a light emergent direction of the reflecting cup 2a, is connected with the cup body of the reflecting cup 2a and is used for reflecting light emitted from the reflecting cup 2a to the lens 4. The lens 4 is located on a reflected light emergent path of the reflecting mirror and is used for projecting the light reflected by the reflecting mirror to form an illuminating light pattern. A focus of the lens 4 is located near the second focus of the reflecting cup 2a, so that an image formed by projection of the lens 4 is clearer.

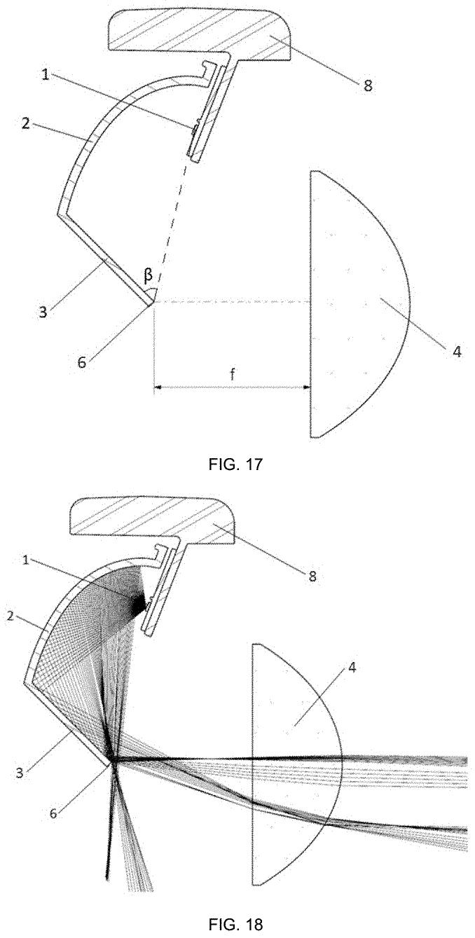

In some embodiments of the present disclosure, as shown in FIG. 15 and FIG. 17, the reflecting mirror and the reflecting cup 2a are integrally molded, so that the reflecting mirror and the reflecting cup 2a form an integrated and stable structural unit. In the structural unit, a position relationship between the reflecting mirror and the reflecting cup 2a is extremely high in stability, does not need to be adjusted and will not be changed during use.

In some embodiments of the present disclosure, as shown in FIG. 15 and FIG. 17, the reflecting cup 2a is shaped as an ellipsoid surface, and in some other embodiments, the reflecting cup 2a is shaped as an ellipsoid-like surface. Specifically, the cup body of the reflecting cup 2a may be shaped as a one-quarter ellipsoid surface or ellipsoid-like surface, namely a shape formed by sectioning an ellipsoid surface or an ellipsoid-like surface along a long axis, and then, sectioning the obtained semi-ellipsoid surface or semi-ellipsoid-like surface along a short axis. The light source 1 is arranged at the first focus on the section along the long axis. Of course, the position of the above section is not restricted in the present disclosure, and even, sectioning in a direction of the long axis may be omitted, so that different requirements on the light source are met. The light emergent opening of the reflecting cup 2a is formed by a cut in a direction of the short axis. The reflecting cup 2a shaped as the ellipsoid surface can uniformly converge the light emitted by the light source 1 located at the first focus to the second focus, so that the formed light pattern is more regular. The reflecting cup 2a shaped as the ellipsoid-like surface is adaptively adjusted on the basis of the ellipsoid surface, so that reflection directions of part of the light are changed purposely. Some accessory structures may be additionally arranged, so that the formed light pattern better meets an illuminating requirement of a vehicle.

In some embodiments of the present disclosure, as shown in FIG. 15 and FIG. 17, an edge of a side, opposite to a side connected with the reflecting cup 2a, of the reflecting mirror is provided with a cutoff line structure 6, and the cutoff line structure 6 is set to be of a shape corresponding to a required bright-dark cutoff line. The cutoff line structure 6 is arranged near the second focus of the reflecting cup 2a, namely the focus of the lens 4. As shown in FIG. 18, light, substantially in Lambertian divergence, emitted by the light source 1 is emitted from the first focus of the reflecting cup 2a to the reflecting cup 2a at various angles, is converged to a direction of the second focus of the reflecting cup 2a after being reflected by the reflecting cup 2a and is emitted to the lens 4 by changing a propagation angle after being reflected by the reflecting mirror arranged near the second focus of the reflecting cup 2a. The cutoff line structure 6 located on the edge of the reflecting mirror forms one side boundary of the reflecting mirror, and the light reflected by the reflecting mirror forms a boundary corresponding to the shape of the cutoff line structure 6 and is then projected by the lens 4 to form a low-beam light pattern with a bright-dark cutoff line. The reflection-type headlamp module of the present disclosure is provided with the cutoff line structure 6, such that the low-beam light pattern with the bright-dark cutoff line can be formed, which is therefore may be used for low-beam illumination. A diagram showing screen illuminance of the low-beam light pattern formed by the reflection-type headlamp module is shown in FIG. 9. The cutoff line structure 6 is arranged near the second focus of the reflecting cup 2a, so that an image of the formed bright-dark cutoff line is clearer.

As a specific embodiment of the present disclosure, the reflecting mirror is in a semi-ellipsoidal shape. In this case, an overall arc-shaped edge of the reflecting mirror is connected with an edge of the light emergent opening of the reflecting cup 2a within a relatively great range. The cutoff line structure 6 is arranged on a straight line edge opposite to the arc-shaped edge, so that the cutoff line structure 6 is located on the edge of the reflecting mirror and near the second focus of the reflecting cup 2a.

In some embodiments of the present disclosure, as shown in FIG. 17, an included angle β between a connecting line of two foci of the reflecting cup 2a and a mirror surface of the reflecting mirror is 30°-60°. A direction for reflecting light depends on the included angle β between the connecting line of the two foci of the reflecting cup 2a, namely the optical axis of the reflecting cup 2a, and the mirror surface of the reflecting mirror 3; and due to the restriction that the focus of the lens 4 is located at the second focus of the reflecting cup 2a, the front and rear length of the headlamp module depends on the included angle β. Meanwhile, there are certain influences on the deformation of the light pattern. When the included angle β ranges from 30° to 60°, the front and rear length of the headlamp module is relatively small, and the deformation of the light pattern is less.

In some embodiments, the light source 1 may include a low-beam light source and a signal light source, thus forming an integrated low-beam module and an integrated signal light module.

The headlamp module of the present disclosure adopts a design solution of the reflection-type headlamp module according to any one of the above embodiments, so as to be capable of achieving a low-beam function and a high-beam function.

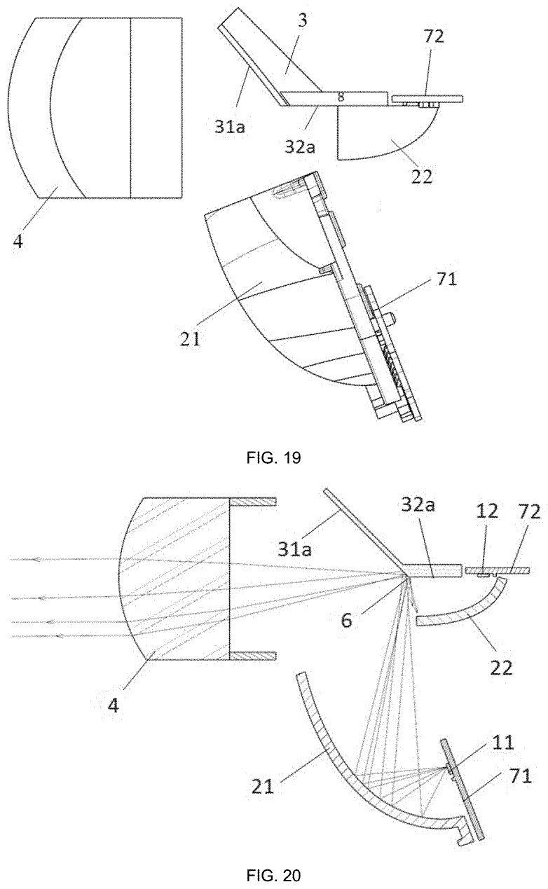

Referring to FIG. 19 to FIG. 22, in an embodiment, the headlamp module of the present disclosure includes a light source 1, a light-collimating element 2, a reflecting element 3 and a lens 4. The light source 1 includes a low-beam light source 11 and a high-beam light source 12. The light-collimating element 2 includes a low-beam collimating element 21 and a high-beam collimating element 22. A low-beam optical component is composed of the low-beam collimating element 21 and the low-beam light source 11 located at a first focus of the low-beam collimating element 21, and a high-beam optical component is composed of the high-beam collimating element 22 and the high-beam light source 12 located at a first focus of the high-beam collimating element 22; and a second focus of the low-beam collimating element 21 and a second focus of the high-beam collimating element 22 are both located in a region of a cutoff line structure 6. In this case, when the low-beam light source 11 is turned on, light is converged near the second focus of the low-beam collimating element 21 by the low-beam collimating element 21; and when the high-beam light source 12 is turned on, light is converged near the second focus of the high-beam collimating element 22 by the high-beam collimating element 22. The reflecting element 3 is of a reflecting structure, a low-beam reflecting surface 31a of the reflecting structure is located on an emergent light path of the low-beam optical component, and a high-beam reflecting surface 32a of the reflecting structure is located on an emergent light path of the high-beam optical component; and emergent light of the low-beam optical component and the high-beam optical component can be emitted to the lens 4 after being reflected by the reflecting structure and can be refracted by the lens 4 to respectively form a low-beam light pattern and a high-beam light pattern. The reflecting structure is provided with a cutoff line structure 6 for forming a bright-dark cutoff line, and a focus of the lens 4 is located in a region of the cutoff line structure 6.

It should be noted that, in the headlamp module of the present disclosure, an installation position of the reflecting structure and an included angle between the low-beam reflecting surface 31a and the high-beam reflecting surface 32a may be set according to a size of a space in the headlamp module, or appearance design requirements of the headlamp module, then, reasonable layout for positions of the low-beam optical component and the high-beam optical component may be realized according to the position of the reflecting structure and the included angle between the low-beam reflecting surface 31a and the high-beam reflecting surface 32a, and the lens 4 is arranged in a light emergent direction of the reflecting structure, in this way, the focus of the lens 4 falls near the cutoff line structure 6 of the reflecting structure, to be capable of forming ideal low-beam light and high-beam light, so that layout for a space structure in the headlamp module is flexibly realized.

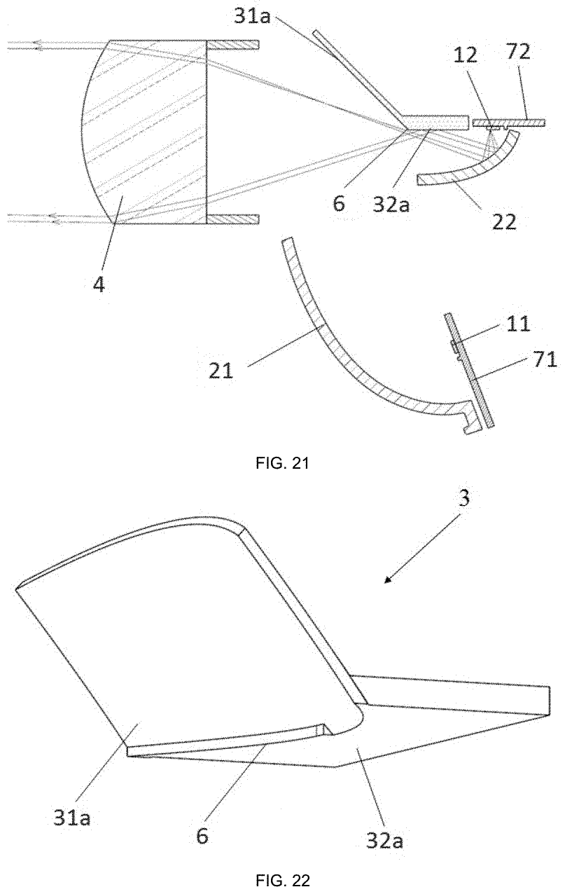

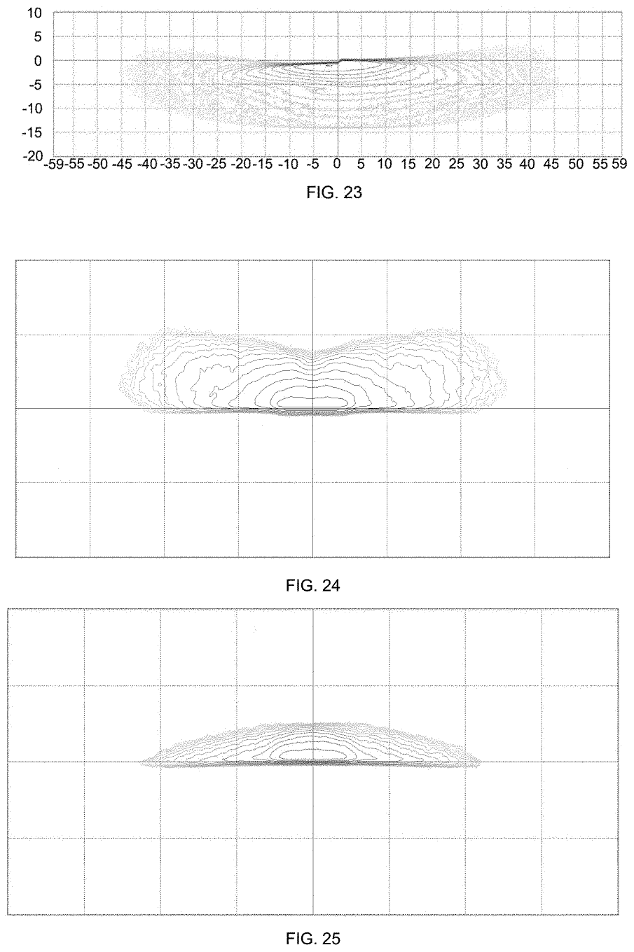

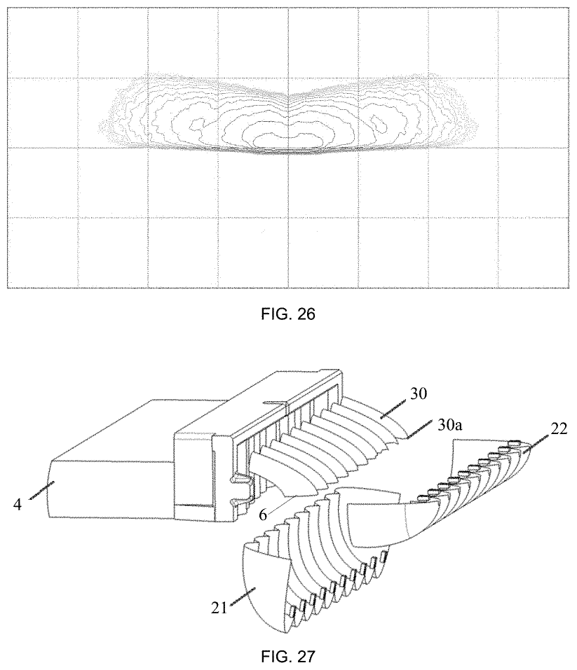

In the headlamp module according to the above technical solution of the present disclosure, as shown in FIG. 19 to FIG. 21, the low-beam light source 11 of the low-beam optical component is turned on alone, emergent light of the low-beam optical component is converged into a region near the cutoff line structure 6 of the reflecting structure, is reflected by the low-beam reflecting surface 31a, is intercepted by the cutoff line structure 6 of the reflecting structure and is emitted by the lens 4 to form a low-beam light pattern as shown in FIG. 23. The high-beam light source 12 of the high-beam optical component is turned on alone, as shown in FIG. 21, emergent light of the high-beam optical component is converged into a region near the cutoff line structure 6 of the reflecting structure, a part of light is directly emitted to a light incident surface of the lens 4 to form a first illuminating light pattern as shown in FIG. 25, and the other part of light is emitted to the high-beam reflecting surface 32a and is emitted to the lens 4 after being reflected by the high-beam reflecting surface 32a to form a second illuminating light pattern as shown in FIG. 26; the above first illuminating light pattern and second illuminating light pattern are superposed to form a high-beam light pattern as shown in FIG. 24; and generally, light sources of the low-beam optical component and the high-beam optical component are turned on at the same time, a high-beam light and a low-beam light are matched to form a superposed total high-beam light pattern.

Therefore, in the headlamp module according to the above technical solution of the present disclosure, the reflecting structure is provided with the cutoff line structure 6 for forming a low-beam bright-dark cutoff line, the emergent light of the low-beam optical component and the high-beam optical component is converged into the region of the cutoff line structure 6, and the reflecting structure is matched with the low-beam optical component and the high-beam optical component in position, so that the emergent light of the low-beam optical component is reflected by the low-beam reflecting surface 31a to form a low-beam light pattern with a bright-dark cutoff line, and the emergent light of the high-beam optical component is reflected by the high-beam reflecting surface 32a to form high-beam light with a relatively large emergent angle. By using the headlamp module with such a structure, there are no mutual effects between light paths of a low-beam optical system and a high-beam optical system, the high-beam light and the low-beam light can be switched without a light shielding plate and a driving mechanism thereof, and switching may be conveniently performed without noise. In addition, by adjusting the installation position of the reflecting structure and the included angle between the low-beam reflecting surface 31a and the high-beam reflecting surface 32a, the flexible layout of the space structure of the headlamp module is realized. Moreover, by changing light paths of part of the light emitted by the high-beam optical component by the high-beam reflecting surface 32a, the brightness of the high-beam light is increased, and a downward irradiation angle of the high-beam light is reduced, such that discomfort of a driver, caused by excessively high brightness in a region close to a vehicle, is avoided, and an actual use requirement of the high-beam light is better met.

As a preferred embodiment, the cutoff line structure 6 is formed at the included angle between the low-beam reflecting surface 31a of the reflecting structure and the high-beam reflecting surface 32a of the reflecting structure.

The low-beam reflecting surface 31a in the present disclosure is a plane or a curved surface, and the high-beam reflecting surface 32a is a plane or a curved surface. If each of the low-beam reflecting surface 31a and the high-beam reflecting surface 32a adopts a planar reflecting mirror, the reflecting structure is simple, and the cutoff line structure 6 is arranged conveniently. If each of the low-beam reflecting surface 31a and the high-beam reflecting surface 32a adopts a curved-surface reflecting mirror, an emergent light pattern of the headlamp module is conveniently secondarily adjusted.

Specifically, the reflecting element 3 is an integrally molded part. The included angle between the low-beam reflecting surface 31a and the high-beam reflecting surface 32a may be better guaranteed by integral molding, so that the optical precision of the headlamp module is guaranteed, and the difficulty of adjusting light is lowered. Of course, the low-beam reflecting surface 31a and the high-beam reflecting surface 32a of the reflecting structure may also be assembled and connected so as to be convenient to produce separately.

Preferably, the low-beam reflecting surface 31a of the reflecting element 3 faces a light emergent surface of the low-beam collimating element 21, and the high-beam reflecting surface 32a of the reflecting structure faces a light emergent surface of the high-beam collimating element 22, in this way, it is convenient for the reflecting structure to receive emergent light of the low-beam collimating element 21 and the high-beam collimating element 22, a light effect of the headlamp module is improved, and the required high-beam light pattern and low-beam light pattern are acquired.

Further, the low-beam collimating element 21 and the high-beam collimating element 22 are both reflecting cups shaped as an ellipsoid surface. The low-beam collimating element 21 and the high-beam collimating element 22 may have various specific structural forms, for example, each of the low-beam collimating element 21 and the high-beam collimating element 22 is the reflecting cup shaped as the ellipsoid surface. The low-beam light source 11 and the high-beam light source 12 are respectively located at first foci of the corresponding reflecting cups shaped as the ellipsoid surface, emergent light of the low-beam light source 11 and the high-beam light source 12 can be respectively converged near second foci of the corresponding reflecting cups shaped as the ellipsoid surface after being reflected by the reflecting cups shaped as the ellipsoid surface by virtue of optical properties of the reflecting cups shaped as the ellipsoid surface and is further matched with the low-beam reflecting surface 31a and the high-beam reflecting surface 32a of the reflecting structure to form a required light pattern; or at least one of the low-beam collimating element 21 and the high-beam collimating element 22 is a collimator, the low-beam light source 11 and/or the high-beam light source 12 are/is located at a focus at an incident end of the corresponding collimator, and light of the low-beam light source 11 and the high-beam light source 12 is emitted from a region near foci at emergent ends of the corresponding collimators after being converged by the collimators.

More preferably, the low-beam optical component further includes a low-beam circuit board 71 for installing the low-beam light source 11; the high-beam optical component further includes a high-beam circuit board 72 for installing the high-beam light source 12; the low-beam circuit board 71 and the high-beam circuit board 72 are provided with heat dissipation elements; and by using the heat radiating elements, the heat dissipation performances of the low-beam circuit board 71 and the high-beam circuit board 72 can be improved, temperatures of the low-beam light source 11 and the high-beam light source 12 may be prevented from being excessively high, and the stability of the low-beam light source 11 and the high-beam light source 12 can be improved.

Referring to FIG. 19 to FIG. 21, the headlamp module in a preferred embodiment of the present disclosure includes the low-beam collimating element 21, the low-beam circuit board 71, the low-beam light source 11, the high-beam collimating element 22, the high-beam circuit board 72, the high-beam light source 12, the reflecting element 3 and the lens 4. The low-beam collimating element 21 and the high-beam collimating element 22 are the reflecting cups shaped as the ellipsoid surface, the low-beam light source 11 is located at the first focus of the low-beam collimating element 21, and the high-beam light source 12 is located at the first focus of the high-beam collimating element 22. The installation position of the reflecting element 3 and the included angle between the low-beam reflecting surface 31a and the high-beam reflecting surface 32a are reasonably set, and then, positions of the low-beam collimating element 21 and the high-beam collimating element 22 are adjusted, so that the low-beam reflecting surface 31a of the reflecting element 3 faces the light emergent surface of the low-beam collimating element 21, and the high-beam reflecting surface 32a of the reflecting element 3 faces the light emergent surface of the high-beam collimating element 22. The low-beam light source 11 is turned on, light of the low-beam light source 11 is converged into the region of the cutoff line structure 6 of the reflecting element 3 after being reflected by the low-beam collimating element 21 and forms the low-beam light pattern as shown in FIG. 23 through the cutoff line structure 6 and the low-beam reflecting surface 31a of the reflecting element 3. Then, when the headlamp module is switched from low-beam light to high-beam light, the low-beam light source 11 and the high-beam light source 12 are turned on at the same time, light of the high-beam light source 12 is converged into the region of the cutoff line structure 6 of the reflecting mirror 3 after being reflected by the high-beam collimating element 22, a part of light is directly emitted to a light incident surface of the lens 4 to form a first illuminating light pattern as shown in FIG. 25, and a part of light is emitted to the high-beam reflecting surface 32a and is emitted to the lens 4 after being reflected by the high-beam reflecting surface 32a to form a second illuminating light pattern as shown in FIG. 26; and the first illuminating light pattern and second illuminating light pattern are superposed to form the high-beam light pattern, as shown in FIG. 24, and matched with the low-beam light pattern to form the total high-beam light pattern, so that switching between the low-beam light and the high-beam light is realized.

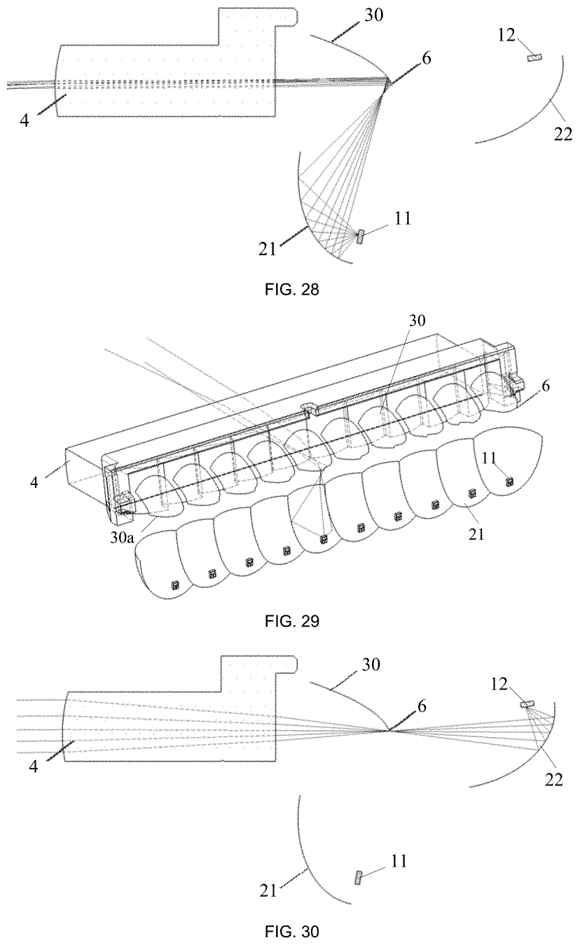

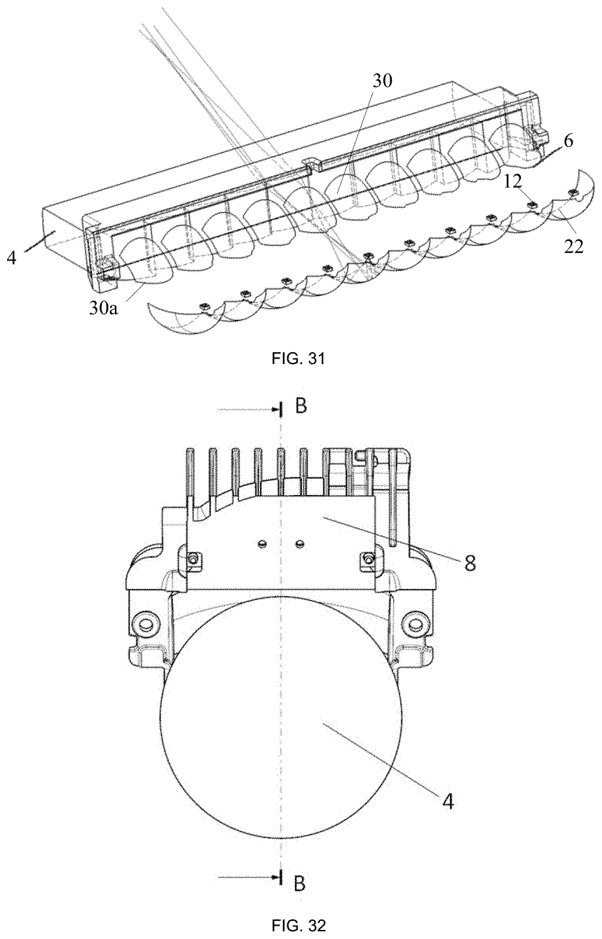

Referring to FIG. 27 to FIG. 31, in an embodiment, the headlamp module of the present disclosure includes a light source, a light-collimating element, a reflecting element and a lens. The light-collimating element includes a low-beam collimating element 21 and a high-beam collimating element 22, and the light source includes a low-beam light source 11 located at a first focus of the low-beam collimating element 21 and a high-beam light source 12 located at a first focus of the high-beam collimating element 22. The low-beam light source 11 and the low-beam collimating element 21 constitute a low-beam optical component, the high-beam light source 12 and the high-beam collimating element 22 constitute a high-beam optical component, the reflecting element includes a reflecting surface 30, the reflecting surface 30 is a paraboloid reflecting surface or a paraboloid-like reflecting surface, and a cutoff line structure 6 for forming a bright-dark cutoff line is provided at an end edge 30a of the reflecting surface 30 close to the low-beam collimating element. As shown in FIG. 28 and FIG. 29, the second focus of the low-beam collimating element 21 coincides with the focus of the reflecting surface 30, and is located between the cutoff line structure 6 and the low-beam collimating element 21. Emergent light of the low-beam optical component, after being converged to the second focus of the low-beam collimating element, is diverged into the reflecting surface 30, and is reflected by the reflecting surface 30 to be directed to the lens 4, and is emitted by the lens 4 to form a low-beam light pattern. As shown in FIG. 30 and FIG. 31, the second focus of the high-beam collimating element 22 coincides with the focus of the lens 4, and is located at the cutoff line structure 6. Emergent light of the high-beam optical component, after being converged to the second focus (i.e., focus of the lens 4) of the high-beam collimating element 22, is diverged into the lens 4, and is refracted by the lens 4 to form a high-beam light pattern.

In this embodiment, as illustrated in FIG. 28 and FIG. 29, when the low-beam light source 11 located at the first focus of the low-beam collimating element 21 is turned on, light emitted from the low-beam light source 11 is diverged into the low-beam collimating element 21 and reflected by the low-beam collimating element 21 to be converged to the second focus of the low-beam collimating element 21. Since the second focus of the low-beam collimating element 21 coincides with the focus of the reflecting surface 30, which is equivalent to that the low-beam light source 11 forms an image at the focus of the reflecting surface 30, the converged light is diverged into the reflecting surface 30, reflected by the reflecting surface 30, and then enters the incident surface of the lens 4 in a parallel manner, and finally emits out through a light emergent surface of the lens 4 to form a low-beam light pattern.

Compared with other embodiments in which the second focus of the low-beam collimating element 21 is provided at the cutoff line structure 6, in the present embodiment, light can be reflected by the reflecting surface 30 and then maximally incident to the lens in a parallel manner, so as to form the low-beam light pattern, therefore, the light loss is less, and the light effect is higher.

In this embodiment, as shown in FIG. 30 and FIG. 31, when the high-beam light source 12 located at the first focus of the high-beam collimating element 22 is turned on, light emitted from the high-beam light source 12 is diverged into the high-beam collimating element 22 and reflected by the high-beam collimating element 22 to be converged to the second focus of the high-beam collimating element 22. Since the second focus of the high-beam collimating element 22 coincides with the focus of the lens 4, which is equivalent to that the high-beam light source 12 forms an image at the focus of the lens 4, the converged light is diverged into the incident surface of the lens 4, and finally emits out through a light emergent surface of the lens 4 to form a high-beam light pattern.

In some embodiments, as shown in FIG. 27, FIG. 28, and FIG. 30, the low-beam optical component formed by the low-beam light source 11 and the low-beam collimating element 21 may be disposed below the lens 4 and the high-beam optical component formed by the high-beam light source 12 and the high-beam collimating element 22, and the cutoff line structure 6 may be disposed at the end edge 30a of a lower end portion of the reflecting surface 30. It should be noted that “below” and “lower end portion” referred to herein are relative to use position of the reflection-type headlamp module. In this manner, as shown in FIG. 30, the low-beam optical component may be arranged away from the light emergent path of the high-beam optical component, so as not to interfere with the high-beam light.

In some embodiments, the reflecting surface 30 may be a curved surface obtained by rotating a parabola or a parabola-like line around a central axis. In such cases, the light utilization ratio is the highest, and thus the obtained low-beam light pattern is also optimal. It can be understood that, without departing from the spirit and concept of the present disclosure, a paraboloid reflecting surface or a paraboloid-like reflecting surface is obtained by rotating a parabola or a parabola-like line around a central axis by a certain angle (for example, 175 degrees, 182 degrees).

In some embodiments, as shown in FIG. 29 and FIG. 31, the low-beam collimating element 21 and the high-beam collimating element 22 may be ellipsoid reflecting mirrors or ellipsoid-like reflecting mirrors.

As appreciated by those skilled in the art, the ellipsoid reflecting mirror has the following optical properties: light emitted from a light source located at any focus of the ellipsoid reflecting mirror or light converged through the focus and emitted, after being reflected by the ellipsoid reflecting mirror, can be converged to another focus region of the ellipsoid reflecting mirror. In this way, when the low-beam collimating element 21 is formed into an ellipsoid reflecting mirror, as shown in FIG. 28 and FIG. 29, emergent light of the low-beam light source 11, located at the first focus of the low-beam collimating element 21, after being reflected by the low-beam collimating element 21, can be converged to the other focus region of the low-beam collimating element 21 (namely, the second focus of the ellipsoid reflecting mirror). By the same reasoning, when the high-beam collimating element 22 is formed into an ellipsoid reflecting mirror, as shown in FIG. 30 and FIG. 31, emergent light of the high-beam light source 12, located at the first focus of the high-beam collimating element 22, after being reflected by the high-beam collimating element 22, can be converged to the region of the cutoff line structure 31 (namely, the second focus of the high-beam collimating element 22).

Besides, as mentioned above, in the present disclosure, an “ellipsoid-like surface” should be understood as having a surface type close to that of an ellipsoid surface and has similar optical characteristics to that of an ellipsoid surface. The “ellipsoid-like reflecting mirror” mentioned in the present surface may be a reflecting mirror formed by performing adaptive adjustment on the basis of the shape of an ellipsoid surface so as to optimize a formed light pattern.

In some embodiments, as shown in FIG. 29 and FIG. 31, the light-collimating element 2 may include a plurality of low-beam collimating elements 21 arranged in a row with each other and a plurality of high-beam collimating elements 22 arranged in a row with each other; the light source 1 may include a plurality of low-beam light sources 11 arranged in one-to-one correspondence with the low-beam collimating elements 21 and a plurality of high-beam light sources 12 arranged in one-to-one correspondence with the high-beam collimating elements 22. The reflecting element may include a plurality of reflecting surfaces 30 arranged in one-to-one correspondence with the low-beam collimating elements 21, and a cutoff line structure 6 for forming a bright-dark cutoff line is provided at an end edge 30a of each reflecting surface 30 close to the low-beam collimating elements 21. In some embodiments, the number of the high-beam collimating elements 22 may be equal to or smaller than that of the low-beam collimating elements 21.

It should be noted that, in the context, when the term “A and B are disposed in one-to-one correspondence” is used, it should be understood that each A is disposed in correspondence with one and only one B. For example, it should be understood herein that each low-beam collimating element 21 is provided corresponding to one and only one light source 11.

According to the embodiments of the present disclosure, by arranging in a row a plurality of low-beam light sources 11, and a plurality of low-beam collimating elements 21 and a plurality of reflecting surfaces 30 in one-to-one correspondence thereto, a low-beam light pattern finally formed can be made brighter. Similarly, by arranging a plurality of high-beam light sources 12 arranged in a row, and a plurality of high-beam collimating elements 22 in one-to-one correspondence thereto, a high-beam light pattern finally formed can be made brighter.

In some embodiments, the lens 4 may be a bidirectional alignment lens, the bidirectional alignment lens may include a light incident portion making horizontal single-direction alignment and a light emergent portion making vertical single-direction alignment, and the light incident portion of the lens 4 may include a plurality of light incident surfaces arranged in one-to-one correspondence with the reflecting surfaces 30. In some embodiments, the light incident surface of the lens 4 may be a curved surface stretched up and down so as to perform left and right alignment for the light, and the light emergent portion of the lens 4 may include a curved surface stretched left and right so as to perform up and down alignment for the light. It should be noted that “up and down” and “left and right” referred to herein are relative to the use position of the reflection-type headlamp module. By using the bidirectional alignment lens, both the light incident portion and the light emergent portion of the lens 4 have a single-direction dimming function, and surface types of two optical surfaces can be independently adjusted, thereby greatly simplifying a dimming step in a light distribution process. In addition, when lighting module of this embodiment is applied to a vehicle, a narrow-opening lens can be realized, and a vehicle having a headlamp in a narrow and long shape can be obtained, which meets market demands.

As shown in FIG. 32 to FIG. 34, as an embodiment of the reflection-type headlamp module of the present disclosure, the reflection-type headlamp module is a high-beam and low-beam integrated headlamp module. The headlamp module includes a light source 1, a light-collimating element 2, a reflecting element 3 and a lens 4. The light source 1 includes a low-beam light source 11 and a high-beam light source 12. The light-collimating element 2 includes a low-beam reflecting cup 21a and a high-beam reflecting cup 22a. The reflecting element 3 includes a low-beam reflecting mirror 31 and a high-beam reflecting mirror 32. It can be seen from FIG. 34 which is a schematic diagram showing a section of a B-B position in FIG. 32 that the low-beam reflecting cup 21a, the low-beam reflecting mirror 31, the high-beam reflecting cup 22a and the high-beam reflecting mirror 32 form a reflecting cup module 2m; and the low-beam reflecting mirror 31 is arranged on an edge of a light emergent opening in a light emergent direction of the low-beam reflecting cup 21a and is connected with a cup body of the low-beam reflecting cup 21a. The low-beam light source 11 is arranged in the low-beam reflecting cup 21a by which the light emitted by the low-beam light source 11 can be reflected to the low-beam reflecting mirror 31, and the light emitted by the low-beam light source 11 can be reflected to the lens 4 by the low-beam reflecting mirror 31 and is projected by the lens 4 to form a low-beam light pattern. The high-beam reflecting mirror 32 is arranged on an edge of a light emergent opening in a light emergent direction of the high-beam reflecting cup 22a and is connected with a cup body of the high-beam reflecting cup 22a. The high-beam light source 12 is arranged in the high-beam reflecting cup 22a by which the light emitted by the high-beam light source 12 can be reflected to a direction of the high-beam reflecting mirror 32, and the light emitted by the high-beam light source 12 can be reflected to the lens 4 by the high-beam reflecting mirror 32 and is projected by the lens 4 to form a high-beam light pattern. The low-beam light source 11 and/or the high-beam light source 12 may adopt an LED light source, or a laser light source, or a halogen lamp light source or any other light sources suitable for being used in a vehicle lamp. When the light source such as the LED light source that needs to dissipate heat is used, a heat radiator 8 may be arranged to dissipate heat of the light source. By using the heat radiator 8, the temperature of the light source can be reduced, and the power and light emitting efficiency of the adopted light source can be increased. A side, far from a wall of the low-beam reflecting cup 21a, of the low-beam reflecting mirror 31 is connected with a side, far from a wall of the high-beam reflecting cup 22a, of the high-beam reflecting mirror 32, so that the low-beam reflecting cup 21a, the low-beam reflecting mirror 31, the high-beam reflecting cup 22a and the high-beam reflecting mirror 32 are connected into a whole to form the modular reflecting cup module 2m. The lens 4 is arranged on reflected light paths of the low-beam reflecting mirror 31 and the high-beam reflecting mirror 32, a focus of the lens 4 is located at a junction of the low-beam reflecting mirror 31 and the high-beam reflecting mirror 32. The light emitted by the low-beam light source 11 irradiates to a lower part of the lens 4 after being reflected by the low-beam reflecting mirror 31 and is projected by the lens 4 to form a low-beam light pattern. The light emitted by the high-beam light source 12 is emitted to an upper part of the lens 4 after being reflected by the high-beam reflecting mirror 32 and is projected by the lens 4 to form a high-beam light pattern.

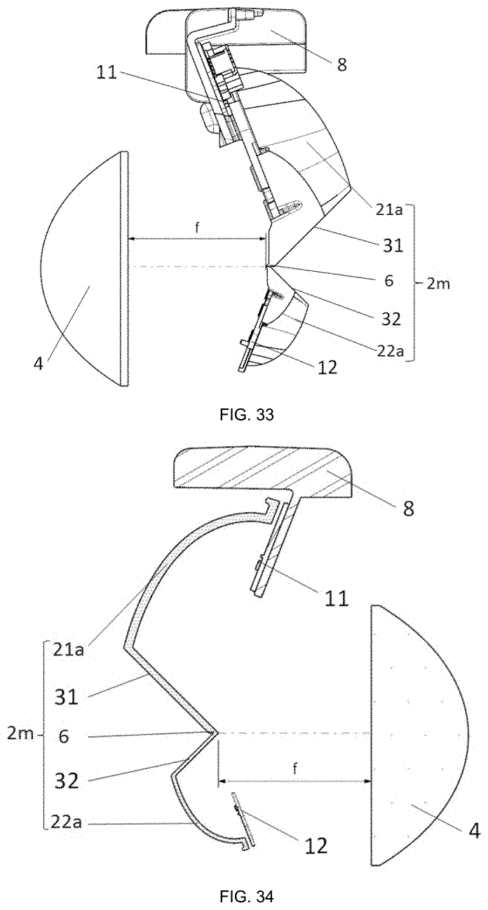

In some embodiments of the high-beam and low-beam integrated headlamp module of the present disclosure, as shown in FIG. 33 and FIG. 34, the low-beam reflecting cup 21a, the low-beam reflecting mirror 31, the high-beam reflecting cup 22a and the high-beam reflecting mirror 32 are integrally molded to form an integral reflecting cup module 2m with a fixed position relationship. In the integrally molded reflecting cup module 2m, the position relationship among the low-beam reflecting cup 21a, the low-beam reflecting mirror 31, the high-beam reflecting cup 22a and the high-beam reflecting mirror 32 is merely decided by a mold used for molding, and the molded reflecting cup module 2m is convenient to use, high in stability and convenient to perform dimming.

In some embodiments of the high-beam and low-beam integrated headlamp module of the present disclosure, the low-beam reflecting cup 21a is shaped as a partial ellipsoid surface with one end provided with a light emergent opening formed in a direction of a long axis of the low-beam reflecting cup 21a. A light emitter of the low-beam light source 11 is arranged at the first focus located at a bottom of the low-beam reflecting cup 21a, and the low-beam reflecting mirror 31 is arranged at the second focus of the low-beam reflecting cup 21a. The high-beam reflecting cup 22a is also shaped as a partial ellipsoid surface with one end provided with a light emergent opening formed in a direction of a long axis of the high-beam reflecting cup 22a. A light emitter of the high-beam light source 12 is arranged at the first focus located at a bottom of the high-beam reflecting cup 22a, and the high-beam reflecting mirror 32 is arranged at the second focus of the high-beam reflecting cup 22a. By using the reflecting cup shaped as the ellipsoid surface, the light emitted by the light source located at the first focus can be uniformly converged to the second focus, so that the formed light pattern is more regular. Each of the low-beam reflecting cup 21a and the high-beam reflecting cup 22a also may be shaped as a partial ellipsoid-like surface with one end provided with a light emergent opening. Each reflecting cup shaped as the ellipsoid-like surface is adaptively adjusted on the basis of the ellipsoid surface, so that reflection directions of a part of light are changed purposely. Meanwhile, some accessory structures may be additionally arranged, so that the formed light pattern better meets an illuminating requirement of a vehicle. Of course, it is also possible that one of the low-beam reflecting cup 21a and the high-beam reflecting cup 22a is shaped as the ellipsoid surface, and the other one is shaped as the ellipsoid-like surface.

In some embodiments of the high-beam and low-beam integrated headlamp module of the present disclosure, as shown in FIG. 33 and FIG. 34, the cutoff line structure 6 is formed at a junction of the low-beam reflecting mirror 31 and the high-beam reflecting mirror 32 and is set to be of a shape corresponding to a required bright-dark cutoff line of the low-beam light pattern. The cutoff line structure 6 is arranged near the second focus of the low-beam reflecting cup 21a, namely the focus of the lens 4. Meanwhile, the second focus of the high-beam reflecting cup 22a is also arranged at the focus of the lens 4.

As an embodiment of the high-beam and low-beam integrated headlamp module of the present disclosure, as shown in FIG. 33 and FIG. 34, the reflecting surfaces of the low-beam reflecting mirror 31 and/or the high-beam reflecting mirror 32 are planes. The reflecting surface which is the plane is capable of reflecting light emitted from a light emergent opening of the reflecting cup to the lens 4 as it is, and the illuminating effect of the formed illuminating light pattern is basically identical to that obtained by directly arranging the lens 4 in the light emergent direction of the reflecting cup.

As an embodiment of the high-beam and low-beam integrated headlamp module of the present disclosure, the reflecting surfaces of the low-beam reflecting mirror 31 and/or the high-beam reflecting mirror 32 are curved surface. By using the reflecting surfaces which are the curved surfaces, a light pattern formed by the light emitted from the light emergent opening of the reflecting cup can be secondarily changed, so that the illuminating light pattern formed by the headlamp module may be more flexibly adjusted.

As an embodiment of the high-beam and low-beam integrated headlamp module of the present disclosure, the reflecting surfaces of the low-beam reflecting mirror 31 and/or the high-beam reflecting mirror 32 may be formed by a plurality of planes or curved surfaces or formed by mixing the plurality of planes and curved surfaces. A plurality of reflecting planes or reflecting curved surfaces may be arranged separately to adjust reflection directions of light emitted to each reflecting surface. By using the reflecting curved surfaces, the distribution of the reflected light may also be secondarily changed, so that a reasonable irradiation light pattern is formed. By setting the shape and reflection direction of each reflecting surface separately, the low-beam light pattern and/or the high-beam light pattern may be freely designed to form an illuminating light pattern meeting a requirement.

In some embodiments of the present disclosure, the reflecting surfaces of the low-beam reflecting mirror 31 and the high-beam reflecting mirror 32 are provided with highly reflective material layers. Of course, when the low-beam reflecting cup 21a, the low-beam reflecting mirror 31, the high-beam reflecting cup 22a and the high-beam reflecting mirror 32 are integrally molded, the reflecting surfaces of the low-beam reflecting cup 21a, the low-beam reflecting mirror 31, the high-beam reflecting cup 22a and the high-beam reflecting mirror 32 may be provided with the same reflective material at the same time. A highly reflective material is capable of reflecting more incident light due to relatively high reflectivity, and thus, loss of light is reduced. An existing highly reflective material is mainly a metal material, and the metal material is also relatively convenient to machine.

In some embodiments of the present disclosure, the highly reflective material layers on the reflecting surfaces of the low-beam reflecting mirror 31 and the high-beam reflecting mirror 32 are aluminum-plated layers or silver-plated layers. The aluminum-plated layers may achieve the reflectivity of 85%-90% and are good in reflecting performance and low in price. The silver-plated layers may achieve the reflectivity of 95% and is excellent in reflecting performance, extremely high in plating layer stability and long in service life. The aluminum-plated layers or the silver-plated layers may also be formed together with the reflecting layer of the reflecting cup during machining.

A formation principle of the illuminating light pattern of the high-beam and low-beam integrated headlamp module of the present disclosure is described below with the embodiment as shown in FIG. 34 as an example.

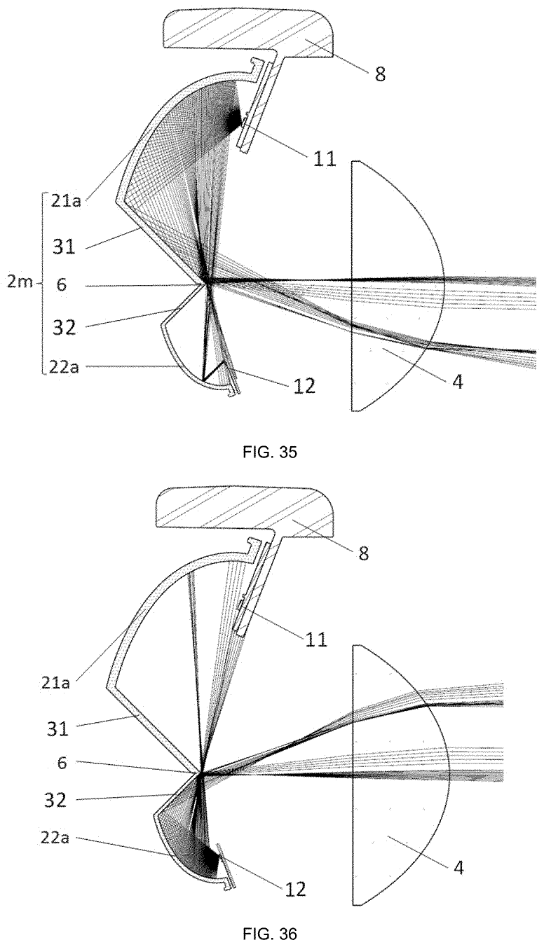

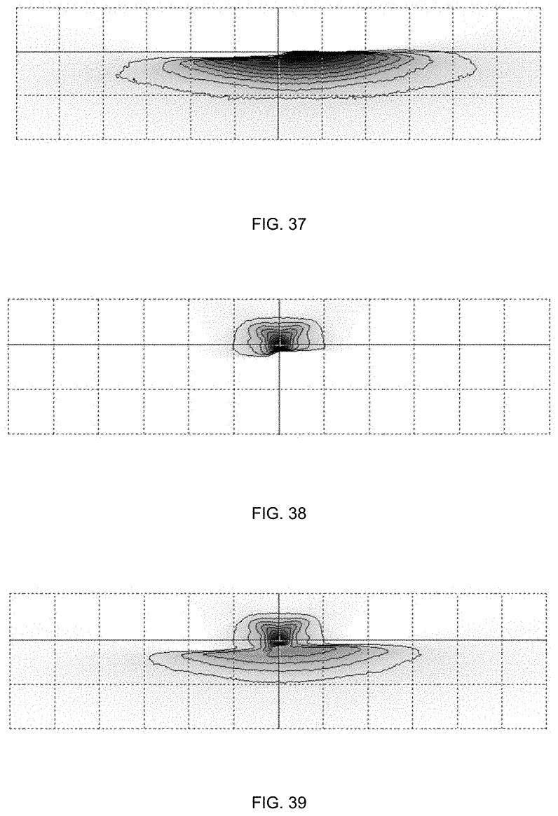

When the low-beam light source 11 works alone, as shown in FIG. 35, the low-beam light source 11 is arranged at the first focus of the low-beam reflecting cup 21a, the light emitted by the low-beam light source 11 is converged to the direction of the second focus after being reflected by the low-beam reflecting cup 21a, is emitted to a lower part of the lens 4 after being reflected by the low-beam reflecting mirror 31 arranged near the second focus and is projected by the lens 4 to form a low-beam light pattern. Since the edge of the low-beam reflecting mirror 31 is provided with the cutoff line structure 6, a part of light emitted to the region is reflected by the cutoff line structure 6 to form a bright region of a bright-dark cutoff line region of the low-beam light pattern, a part of light leaks near the edge of the cutoff line structure 6 to form a dark region of the bright-dark cutoff line region of the low-beam light pattern. The cutoff line structure 6 is arranged near the second focus of the low-beam reflecting cup 21a, so that a low-beam light pattern with a clear bright-dark cutoff line can be formed. When the low-beam light source 11 works alone, a diagram showing screen illuminance of the formed low-beam light pattern is shown in FIG. 37.

When the high-beam light source 12 works alone, as shown in FIG. 36, the high-beam light source 12 is arranged at the first focus of the high-beam reflecting cup 22a, the light emitted by the high-beam light source 12 is converged to the direction of the second focus after being reflected by the low-beam reflecting cup 22a, is emitted to an upper part of the lens 4 after being reflected by the high-beam reflecting mirror 32 arranged near the second focus and is projected by the lens 4 to form a high-beam light pattern. When the high-beam light source works alone, a diagram showing screen illuminance of the formed high-beam light pattern is shown in FIG. 38.

When the high-beam light source 12 and the low-beam light source 11 work at the same time, the light emitted by the high-beam light source 12 is reflected by the high-beam reflecting cup 22a and the high-beam reflecting mirror 32 and is projected by the lens 4 to form a high-beam light pattern. The light emitted by the low-beam light source 11 is reflected by the low-beam reflecting cup 21a and the low-beam reflecting mirror 31 with the cutoff line structure 6 and is projected by the lens 4 to form a low-beam light pattern. A light barrier in a traditional low-beam module is omitted to avoid shielding a high-beam light path by the light barrier, therefore, the high-beam light pattern and the low-beam light pattern can be completely superposed. When the superposed light is used for high-beam illumination, illumination within a long/short distance is relatively clear, and the illuminating effect is good. A diagram showing screen illuminance of the light pattern superposed by high-beam light and low-beam light is shown in FIG. 39.

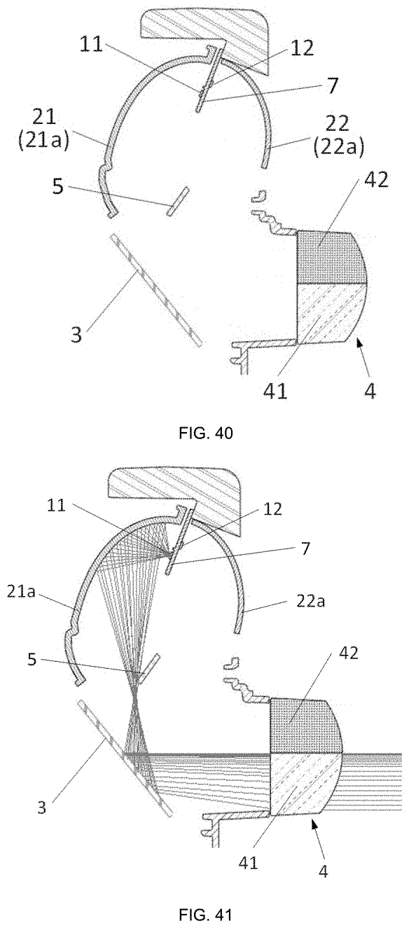

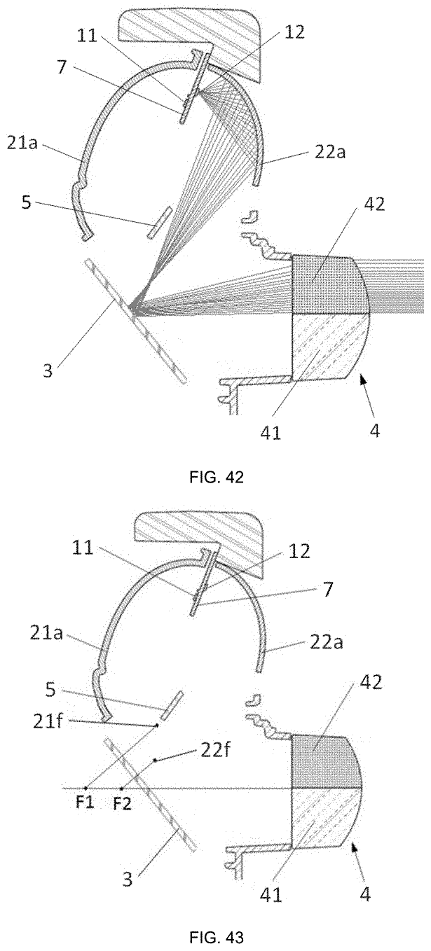

As shown in FIG. 40, as an embodiment of the reflection-type headlamp module of the present disclosure, the reflection-type headlamp module is a high-beam and low-beam integrated headlamp module. The headlamp module includes a light source 1, a light-collimating element 2, a reflecting element 3, a lens 4 and a light shielding plate 5. The light source 1 includes a low-beam light source 11 and a high-beam light source 12. The light-collimating element 2 includes a low-beam collimating element 21 and a high-beam collimating element 22. The reflecting element 3 is a reflecting mirror. A reflecting cup, a collimator or any other optical element meeting a requirement may be selected as each of the low-beam collimating element 21 and the high-beam collimating element 22. The low-beam light source 11 and the high-beam light source 12 are arranged at different relative positions of the corresponding light-collimating element 2 according to the different selected low-beam collimating element 21 and high-beam collimating element 22. When the reflecting cup is selected, the light source may be arranged on a focus located at a bottom of the corresponding reflecting cup; and when the collimator is selected, the light source may be arranged at a light incident opening of the corresponding collimator. As shown in FIG. 41, light emitted by the low-beam light source 11 can be received and gathered by the low-beam collimating element 21 and can be projected by a light emergent opening; the light shielding plate 5 is arranged on a projection light path of the low-beam collimating element 21 and is capable of shielding the light emitted by the low-beam light source 11 and projected by the low-beam collimating element 21; and the light after being shielded is emitted to the reflecting element 3 located on the projection light path of the low-beam collimating element 21, is reflected to the lens 4 by the reflecting element 3 and is projected to a road surface by the lens 4 to form a low-beam light pattern with a bright-dark cutoff line. A diagram showing screen illuminance of the formed low-beam light pattern is shown in FIG. 9. As shown in FIG. 42, light emitted by the high-beam light source 12 can be received and gathered by the high-beam collimating element 22 and is projected by a light emergent opening; meanwhile, the reflecting element 3 is located on a projection light path of the high-beam collimating element 22 and is capable of reflecting the light emitted by the high-beam light source 12 to the lens 4, and the light is projected to a road surface by the lens 4 to form a high-beam light pattern. A diagram showing screen illuminance of the formed high-beam light pattern is shown in FIG. 10.

In some embodiments of the high-beam and low-beam integrated headlamp module of the present disclosure, as shown in FIG. 40 and FIG. 41, a low-beam reflecting cup 21a is selected as the low-beam collimating element 21. The low-beam reflecting cup 21a is shaped as a curved surface with a first focus and a second focus, and the low-beam light source 11 is arranged at the first focus located at a bottom of the low-beam reflecting cup 21a, so that more light emitted by the low-beam light source 11 can be converged to the second focus located at the side of a light emergent opening of the low-beam reflecting cup 21a. The light shielding plate 5 is arranged in a second focus region of the low-beam reflecting cup 21a to be capable of shielding low-beam light converged to the second focus of the low-beam reflecting cup 21a, so that the low-beam light pattern with the bright-dark cutoff line is formed.

In some embodiments of the high-beam and low-beam integrated headlamp module of the present disclosure, as shown in FIG. 40 and FIG. 42, a high-beam reflecting cup 22a is selected as the high-beam collimating element 22. The high-beam reflecting cup 22a is shaped as a curved surface with a first focus and a second focus, and the high-beam light source 12 is arranged at the first focus located at the bottom of the high-beam reflecting cup 22a, so that more light emitted by the high-beam light source 12 can be converged to the second focus located at the side of a light emergent opening of the high-beam reflecting cup 22a and is then emitted from the second focus of the high-beam reflecting cup 22a to form a high-beam light pattern.

In some embodiments of the high-beam and low-beam integrated headlamp module of the present disclosure, as shown in FIG. 40 and FIG. 41, the low-beam reflecting cup 21a is shaped as an ellipsoid surface, but in some other embodiments, the low-beam reflecting cup 21a is shaped as an ellipsoid-like surface. Generally, the bottom and the light emergent opening of the low-beam reflecting cup 21a are respectively located at two ends in a direction of a long axis. The low-beam light source 11 is arranged at the first focus of the low-beam reflecting cup 21a, and the light emitted by the low-beam light source 11 located at the first focus can be uniformly converged to the second focus by the low-beam reflecting cup 21a shaped as the ellipsoid surface, so that the formed light pattern is more regular. The low-beam reflecting cup 21a shaped as the ellipsoid-like surface is adaptively adjusted on the basis of the ellipsoid surface, so that the reflection directions of a part of light are changed purposely, and finally, the brightness of the part of light in an illuminating light pattern is changed. Some accessory structures may be additionally arranged on the basis of the ellipsoid surface, so that the formed light pattern better meets an illuminating requirement of a vehicle.

In some embodiments of the high-beam and low-beam integrated headlamp module of the present disclosure, as shown in FIG. 40 and FIG. 42, the high-beam reflecting cup 22a is shaped as an ellipsoid surface, and in some other embodiments, the high-beam reflecting cup 22a is shaped as an ellipsoid-like surface. Generally, the bottom and the light emergent opening of the high-beam reflecting cup 22a are respectively located at two ends in a direction of a long axis. The high-beam light source 12 is arranged at the first focus of the high-beam reflecting cup 22a, and the light emitted by the high-beam light source 12 located at the first focus can be uniformly converged to the second focus by the high-beam reflecting cup 22a shaped as the ellipsoid surface, so that the formed light pattern is more regular. The high-beam reflecting cup 22a shaped as the ellipsoid-like surface is obtained by adaptively adjusting the ellipsoid surface, so that the reflection directions of a part of light are changed purposely, and finally, the brightness of the part of light in the illuminating light pattern is changed. Some accessory structures may be additionally arranged on the basis of the ellipsoid, so that the formed light pattern better meets an illuminating requirement of a vehicle.

As an embodiment of the high-beam and low-beam integrated headlamp module of the present disclosure, as shown in FIG. 40 to FIG. 42, the high-beam and low-beam integrated headlamp module of the present disclosure is further provided with a PCB 7. Each of the low-beam light source 11 and the high-beam light source 12 is an LED light source, and the low-beam light source 11 and the high-beam light source 12 are respectively arranged on opposite surfaces of the PCB 7. Of course, both the low-beam reflecting cup 21a and the high-beam reflecting cup 22a are also arranged at two sides of the PCB 7. In this way, a low-beam part and a high-beam part of the high-beam and low-beam integrated headlamp module of the present disclosure are more compact in structure, which is beneficial to the reduction of a space occupied by the module. Meanwhile, due to such a layout, an optical axis formed by connecting the first focus and the second focus of the low-beam reflecting cup 21a is basically parallel to an optical axis formed by connecting the first focus and the second focus of the high-beam reflecting cup 22a, an included angle between low-beam light emitted from the light emergent opening of the low-beam reflecting cup 21a and high-beam light emitted from the light emergent opening of the high-beam reflecting cup 22a is also very small, and the low-beam light and the high-beam light are close to each other so as to be favorably reflected by the reflecting element 3. The PCB 7 may be further provided with a heat radiating layer to improve an effect on dissipating heat generated by the low-beam light source 11 and the high-beam light source 12.

In some embodiments of the high-beam and low-beam integrated headlamp module of the present disclosure, as shown in FIG. 40 to FIG. 43, the lens 4 includes a low-beam region 41 and a high-beam region 42, the low-beam region 41 is arranged at the lower part of the lens 4, and the high-beam region 42 is arranged at the upper part of the lens 4. A focus F1 of the low-beam region 41 and a focus F2 of the high-beam region 42 are not at the same position. In the present embodiment, both the focus F1 of the low-beam region 41 and the focus F2 of the high-beam region 42 are located at a central axis of the lens 4, that is, the low-beam region 41 and the high-beam region 42 have the same optical axis, which is not limited in the present disclosure, and also the low-beam region 41 and the high-beam region 42 have different optical axes. The different foci of the low-beam region 41 and the high-beam region 42 may be formed by arranging different curved surfaces on front and rear surfaces of the low-beam region 41 and the high-beam region 42 or formed by adopting light transmitting materials with different refractive indexes in the low-beam region 41 and the high-beam region 42. As shown in FIG. 43, the second focus of the low-beam reflecting cup 21a is arranged at a low-beam second focus position 21f, and the focus F1 of the low-beam region 41 and the low-beam second focus position 21f are symmetrically arranged relative to the reflecting surface of the reflecting element 3, in other words, the focus F1 of the low-beam region 41 is located at a mirror point of the low-beam second focus position 21f relative to the reflecting element 3. In this case, the light emitted from the low-beam light source 11 is converged to the second focus, namely the low-beam second focus position 21f, of the low-beam reflecting cup 21a after being reflected by the low-beam reflecting cup 21a, is then emitted from the low-beam second focus position 21f to the reflecting element 3 and is emitted to the low-beam region 41 of the lens 4 after being reflected by the reflecting surface of the reflecting element 3. The light emitted by the reflecting surface of the reflecting element 3, which is equivalent to being emitted from the mirror point of the low-beam second focus position 21f relative to the reflecting element 3, i.e., the focus F1 of the low-beam region 41, is directly emitted to the low-beam region 41, and is projected after being aligned by the low-beam region 41 to form a low-beam light pattern. The second focus of the high-beam reflecting cup 22a is arranged at a high-beam second focus position 22f, and the focus F2 of the high-beam region 42 and the high-beam second focus position 22f are symmetrically arranged relative to the reflecting surface of the reflecting element 3, in other words, the focus F2 of the high-beam region 42 is located at a mirror point of the high-beam second focus position 22f relative to the reflecting element 3. In this case, the light emitted from the high-beam light source 12 is converged to the second focus, namely the high-beam second focus position 22f, of the high-beam reflecting cup 22a after being reflected by the high-beam reflecting cup 22a, is then emitted from the high-beam second focus position 22f to the reflecting element 3 and is emitted to the high-beam region 42 of the lens 4 after being reflected by the reflecting surface of the reflecting element 3. The light emitted by the reflecting surface of the reflecting element 3, which is equivalent to being emitted from the mirror point of the high-beam second focus position 22f relative to the reflecting element 3, i.e., the focus F2 of the high-beam region 42, is directly emitted to the high-beam region 42, and is projected after being aligned by the high-beam region 42 to form a high-beam light pattern. In a traditional high-beam and low-beam integrated headlamp module, in order to form relatively clear high- and low-beam light patterns, the second focus of the low-beam reflecting cup 21a, the second focus of the high-beam reflecting cup 22a and the focus of the lens 4 are required to be arranged on the same position, and meanwhile, the light shielding plate 5 is required to be arranged near the second focus of the low-beam reflecting cup 21a, in this way, a high-beam light path may be shielded by the light shielding plate 5 to affect the formation of the high-beam light pattern. In the embodiment, the focus F1 of the low-beam region 41 is separated from the focus F2 of the high-beam region 42, so that influences of the light shielding plate 5 to the high-beam light path is successfully avoided, and the formed high-beam light pattern is more uniform and complete.

In some embodiments of the high-beam and low-beam integrated headlamp module of the present disclosure, the reflecting surface of the reflecting element 3 is a plane. The reflecting surface which is the plane is capable of reflecting the light emitted from the light emergent openings of the low-beam reflecting cup 21a and/or the high-beam reflecting cup 22a to the lens 4 as it is, which is the same as that the lens 4 is directly arranged in the light emergent directions of the low-beam reflecting cup 21a and/or the high-beam reflecting cup 22a. In some other embodiments, the reflecting surface of the reflecting element 3 is a curved surface. By using the reflecting surface which is the curved surface, light patterns formed by light emitted from the low-beam reflecting cup 21a and/or the high-beam reflecting cup 22a may be secondarily changed, so that the light pattern formed by the headlamp module may be more flexibly designed.

According to the above technical solutions, due to the arrangement of the reflecting element 3 in the reflection-type headlamp module of the present disclosure, the light converged by the light-collimating element 2 may be reflected, and an original irradiation direction of light may be changed, so that the light-collimating element 2 does not occupy the length of the headlamp module in the front and rear direction, and a front and rear length of the headlamp module is effectively reduced. For example, for the headlamp module provided with the reflecting cup 2a as the light-collimating element, due to the arrangement of the reflecting element 3, the original irradiation direction of light is changed, the restriction that a front and rear length of a traditional headlamp module has to be greater than the sum of a focal length f1 of the lens 4 and a distance f2 from the first focus to the second focus of the reflecting cup 2a is broken, and the front and rear length of the headlamp module can be reduced to a length equivalent to the focal length f1 of the lens 4. By adjusting the angles of the reflecting element 3 and the optical axes of the lens 4, a height of the light pattern formed by the headlamp module may be conveniently adjusted. Due to the design of the shape of the reflecting surface of the reflecting element 3, the shape of the light pattern of the headlamp module may be adjusted, and thus, the illuminating effect of the headlamp module is better. In a low-beam reflection-type headlamp module of the present disclosure, the light shielding plate 5 is replaced with the reflecting element 3, the reflecting element 3 is provided with the cutoff line structure 6 capable forming the bright-dark cutoff line, and then, the low-beam reflection-type headlamp module may be reduced in front and rear size and is more compact in structure and capable of meeting overall design requirements of more vehicle lamps. In the reflection-type headlamp module of the present disclosure, the reflecting mirror is directly connected to the reflecting cup and is even integrally molded with the reflecting cup, so that the reflection-type headlamp module is simpler to produce and maintain, and the stability of the illuminating light pattern is improved. The edge of the reflecting mirror is provided with the cutoff line forming structure, and the bright-dark cutoff line is formed by virtue of the edge of the reflecting mirror, so that not only may a traditional light barrier be omitted, but also the cutoff line forming structure is fixed in position, capable of preventing the bright-dark cutoff line of the illuminating light pattern from shifting in use and can make the light pattern stability extremely high. The reflection-type headlamp module can be used for high-beam illumination when not being provided with the cutoff line forming structure and can be used for low-beam illumination when being provided with the cutoff line forming structure.

In the headlamp module of the present disclosure, the reflecting structure is provided with the cutoff line structure 6 for forming the bright-dark cutoff line, and the emergent light of the low-beam optical component and the high-beam optical component is converged into the region of the cutoff line structure 6; due to the cooperation of positions of the reflecting structure and each of the low-beam optical component and the high-beam optical component, there are no mutual influences between light paths of a low-beam optical system and a high-beam optical system, the high-beam light and the low-beam light can be switched without a light shielding plate and a driving mechanism thereof, and switching may be conveniently performed without noise. In addition, by adjusting the installation position of the reflecting structure or the included angle between the low-beam reflecting surface 31a and the high-beam reflecting surface 32a, the flexible layout of the space structure of the headlamp module may be realized. Moreover, by changing light paths of part of the light emitted by the high-beam optical component by the high-beam reflecting surface 32a, the brightness of the high-beam light may be increased, and a downward irradiation angle of the high-beam light may be reduced, such that the discomfort of a driver, caused by excessively high brightness in a region close to a vehicle, is avoided, and an actual use requirement of the high-beam light is better met. The height of the low-beam light may be adjusted by adjusting an inclination angle of the low-beam reflecting surface 31a relative to a horizontal line. In the high-beam and low-beam integrated headlamp module of the present disclosure, the low-beam reflecting cup, the low-beam reflecting mirror, the high-beam reflecting mirror and the high-beam reflecting cup are interconnected together by the adopted reflecting cup module, so that the installation and debugging of the headlamp module are simplified, and the structural stability of the headlamp module is high. The low-beam reflecting mirror 31 and the high-beam reflecting mirror 32 are adopted to reflect the high-beam light and the low-beam light to change the propagation directions of the light, so that it is not necessary for the arrangement of the lens and the long axes of the reflecting cup to be on the same straight line, and the length of the headlamp module in the front and rear direction is effectively reduced. Due to the arrangement of the cutoff line structure 6 at the junction of the low-beam reflecting mirror 31 and the high-beam reflecting mirror 32, a traditional light barrier is omitted, the structure of the headlamp module is simplified, influences of the light barrier to the high-beam light path are avoided, the light barrier in a working state is prevented from shielding the high-beam light when a low-beam submodule and a high-beam submodule of a traditional high-beam and low-beam integrated headlamp module work at the same time, and when the high-beam light source and the low-beam light source work at the same time, a complete light pattern superposed by high-beam light and low-beam light can be formed to improve the illuminating effect. In the high-beam and low-beam integrated headlamp module of the present disclosure, the reflecting element 3 is capable of reflecting the light on the low-beam light path and the high-beam light path to change the propagation directions of the low-beam light and the high-beam light, so that it is not necessary to arrange the low-beam light source 11, the low-beam collimating element 21, the light shielding plate 5 and the lens 4 of the low-beam module of the headlamp module in the same direction; similarly, it is also unnecessary to arrange the high-beam light source 12, the high-beam collimating element 22 and the lens 4 of the high-beam module in the same direction, so that the length of the headlamp module in the front and rear direction is effectively reduced. Due to the adoption of the technical solution that the low-beam light source 11 and the high-beam light source 12 are arranged on the opposite surfaces of the PCB 7, the low-beam reflecting cup 21a and the high-beam reflecting cup 22a can also be arranged on the opposite surfaces of the PCB 7, the low-beam reflecting cup 21a and the high-beam reflecting cup 22a are more compactly arranged, the space occupied by the headlamp module is smaller, and also, the reflecting element 3 is arranged more conveniently. Due to the design that the low-beam region 41 and the high-beam region 42 of the lens 4 have different foci, the light shielding plate 5 located near the second focus of the low-beam reflecting cup 21a is separated from the second focus of the high-beam reflecting cup 22a, and the light shielding plate 5 is prevented from shielding the high-beam light path, so that the high-beam light pattern is more complete and uniform, and the illuminating effect is better.

The reflection-type headlamp module of the present disclosure is used in a headlamp of the present disclosure, so that the front and rear length of the headlamp may be designed to be smaller, and the degree of freedom for designing the headlamp is increased. Moreover, the illuminating light pattern can be adjusted more conveniently, and the stability of the illuminating light pattern is higher. Due to adoption of the high-beam and low-beam integrated headlamp module of the present disclosure, the headlamp is good in illuminating effect, high in light pattern stability, long in service life, small in front and rear diameter, small in space occupied and high in degree of freedom during design.

Due to the adoption of the headlamp of the present disclosure, a vehicle of the present disclosure also has the above beneficial effects.

In the description of the present disclosure, reference terms such as “some embodiments”, “an embodiment” and “an example” mean that specific features, structures, materials or features described in conjunction with the embodiment or example are included in at least one embodiment or example of the present disclosure. In the present disclosure, schematic statements for the above terms do not necessarily refer to the same embodiment or example. Moreover, the described specific features, structures, materials or features may be combined in an appropriate way in any one or more embodiments or examples.

Preferred embodiments of the present disclosure are described in detail above in conjunction with the accompanying drawings, however, the present disclosure is not limited thereto. The technical solutions of the present disclosure can be subjected to various simple modifications including combination of various specific technical features in any appropriate ways within the range of the technical concept of the present disclosure, and in order to avoid unnecessary repetition, various possible combination ways will not be described additionally in the present disclosure. However, these simple modifications and combinations should be also regarded as contents disclosed by the present disclosure and fall within the scope of protection of the present disclosure.

What is claimed is:

1. A reflection-type headlamp module, comprising:
a light source;
a light-collimating element;
a reflecting element; and
a lens;
the light-collimating element being suitable for converging light emitted by the light source and projecting the light, wherein:
the reflecting element is arranged on an emergent light path of the light-collimating element so as to be suitable for reflecting the light emitted by the light source to the lens; and
the light reflected by the reflecting element is projected by the lens to form an illuminating light pattern.

2. The reflection-type headlamp module according to claim 1, wherein the reflecting element is suitable for adjusting an included angle between a reflecting surface of the reflecting element and an optical axis of the lens.

3. The reflection-type headlamp module according to claim 1, wherein
the reflection-type headlamp module is a low-beam reflection-type headlamp module, and a low-beam light propagation path is formed in the low-beam reflection-type headlamp module;
the light source is a low-beam light source;
the low-beam light source, the light-collimating element, the reflecting element and the lens are sequentially arranged on the low-beam light propagation path;
the reflecting element is provided with a cutoff line structure for forming a bright-dark cutoff line;
a reflecting surface of the reflecting element is located on the emergent light path of the light-collimating element, and the cutoff line structure is arranged on an edge of an end, close to the light-collimating element, of the reflecting surface of the reflecting element; and
light of the low-beam light source is suitable for being converged to the reflecting element by the light-collimating element, is reflected to the lens by the reflecting element and is projected by the lens to form an illuminating low-beam light pattern.

4. The reflection-type headlamp module according to claim 3, wherein
the light-collimating element is a reflecting cup, and the reflecting cup is shaped as a curved surface with a first focus and a second focus;
the low-beam light source is located at the first focus of the reflecting cup; and
the cutoff line structure is located at the second focus of the reflecting cup; or the light-collimating element is a reflecting cup shaped as an ellipsoid surface, an ellipsoid-like surface, a paraboloid or a paraboloid-like surface; or
the reflecting element is a planar reflecting mirror or a curved-surface reflecting mirror.

5. The reflection-type headlamp module according to claim 1, wherein
the light-collimating element is a reflecting cup; and
an included angle between an optical axis of the reflecting cup and an optical axis of the lens is between 60° and 120°.

6. The reflection-type headlamp module according to claim 1, wherein the light-collimating element is a reflecting cup, and one side of the reflecting element is arranged or integrally molded on an edge of a light emergent opening in a light emergent direction of the reflecting cup, and the lens is located on a reflected light emergent path of the reflecting element, and a focus of the lens is located at a second focus of the reflecting cup.

7. The reflection-type headlamp module according to claim 1, wherein the reflection-type headlamp module can achieve a low-beam function and a high-beam function.

8. The reflection-type headlamp module according to claim 7, wherein
the light-collimating element comprises a low-beam collimating element and a high-beam collimating element;
the light source comprises a low-beam light source located at a first focus of the low-beam collimating element and a high-beam light source located at a first focus of the high-beam collimating element;
the low-beam light source and the low-beam collimating element form a low-beam optical component comprising the low-beam light source and the low-beam collimating element;
the high-beam light source and the high-beam collimating element form a high-beam optical component comprising the high-beam light source and the high-beam collimating element;
the reflecting element is of a reflecting structure;
a low-beam reflecting surface of the reflecting structure is located on an emergent light path of the low-beam optical component, and a high-beam reflecting surface of the reflecting structure is located on an emergent light path of the high-beam optical component; and
emergent light of the low-beam optical component and the high-beam optical component can irradiate to the lens after being reflected by the reflecting structure and can be refracted by the lens to respectively form a low-beam light pattern and a high-beam light pattern, wherein
the reflecting structure is provided with a cutoff line structure for forming a bright-dark cutoff line, a focus of the lens is located in a region of the cutoff line structure; and
a second focus of the low-beam collimating element and a second focus of the high-beam collimating element are both located in the region of the cutoff line structure.

9. The reflection-type headlamp module according to claim 8, wherein
the cutoff line structure is formed at an included angle between the low-beam reflecting surface of the reflecting structure and the high-beam reflecting surface of the reflecting structure;
the low-beam reflecting surface is a plane or a curved surface; and
the high-beam reflecting surface is a plane or a curved surface.

10. The reflection-type headlamp module according to claim 9, wherein the reflecting element is an integrally molded part.

11. The reflection-type headlamp module according to claim 7, wherein
the light-collimating element comprises a low-beam collimating element and a high-beam collimating element;
the light source comprises a low-beam light source located at a first focus of the low-beam collimating element and a high-beam light source located at a first focus of the high-beam collimating element;
the low-beam light source and the low-beam collimating element form a low-beam optical component;
the high-beam light source and the high-beam collimating element form a high-beam optical component;
the reflecting element comprises a reflecting surface, the reflecting surface is a reflecting surface shaped as a paraboloid or a reflecting surface shaped as a paraboloid-like surface, and a cutoff line structure for forming a bright-dark cutoff line is provided at an end edge of the reflecting surface close to the low-beam collimating element;
a second focus of the low-beam collimating element coincides with a focus of the reflecting surface, and is located between the cutoff line structure and the low-beam collimating element, emergent light of the low-beam optical component, after being converged to the second focus of the low-beam collimating element, is diverged into the reflecting surface, and is reflected by the reflecting surface to be directed to the lens, and is emitted by the lens to form a low-beam light pattern; and
a second focus of the high-beam collimating element coincides with a focus of the lens, and is located at the cutoff line structure, emergent light of the high-beam optical component, after being converged to the focus of the lens, is diverged into the lens, and is refracted by the lens to form a high-beam light pattern.

12. The reflection-type headlamp module according to claim 11, wherein the low-beam optical component is disposed below the lens and the high-beam optical component, and the cutoff line structure is disposed at an end edge of a lower end portion of the reflecting surface.

13. The reflection-type headlamp module according to claim 11, wherein the reflecting surface is a curved surface obtained by rotating a parabola or a parabola-like line around a central axis.

14. The reflection-type headlamp module according to claim 11, wherein the low-beam collimating element and the high-beam collimating element are reflecting mirrors shaped as an ellipsoid surface or reflecting mirror shaped as an ellipsoid-like surface.

15. The reflection-type headlamp module according to claim 11, wherein
the light-collimating element comprises a plurality of low-beam collimating elements arranged in a row with each other and a plurality of high-beam collimating elements arranged in a row with each other;
the light source comprises a plurality of low-beam light sources arranged in one-to-one correspondence with the low-beam collimating elements and a plurality of high-beam light sources arranged in one-to-one correspondence with the high-beam collimating elements; and
the reflecting element comprises a plurality of reflecting surfaces arranged in one-to-one correspondence with the low-beam collimating elements, and a cutoff line structure for forming a bright-dark cutoff line is provided at an end edge of each of the reflecting surfaces close to the low-beam collimating elements.

16. The reflection-type headlamp module according to claim 15, wherein the lens is a bidirectional alignment lens, the bidirectional alignment lens comprises a light incident portion making horizontal single-direction alignment and a light emergent portion making vertical single-direction alignment, and the light incident portion comprises a plurality of light incident surfaces arranged in one-to-one correspondence with the reflecting surfaces.

17. The reflection-type headlamp module according to claim 7, wherein
the reflection-type headlamp module is a high-beam and low-beam integrated headlamp module;
the light source comprises a low-beam light source and a high-beam light source;
the light-collimating element comprises a low-beam reflecting cup and a high-beam reflecting cup;
the reflecting element comprises a low-beam reflecting mirror and a high-beam reflecting mirror;
the low-beam reflecting cup, the low-beam reflecting mirror, the high-beam reflecting cup and the high-beam reflecting mirror form a reflecting cup module;
the low-beam light source and the high-beam light source are located in the reflecting cup module;
the lens is located in a light emergent direction of the reflecting cup module;
the low-beam reflecting mirror is arranged on an edge of a light emergent opening in a light emergent direction of the low-beam reflecting cup so as to be suitable for reflecting light emitted by the low-beam light source to the lens to form a low-beam light pattern;
the high-beam reflecting mirror is arranged on an edge of a light emergent opening in a light emergent direction of the high-beam reflecting cup so as to be suitable for reflecting light emitted by the high-beam light source to the lens to form a high-beam light pattern; and
a side, far from a wall of the low-beam reflecting cup, of the low-beam reflecting mirror is connected with a side, far from a wall of the high-beam reflecting cup, of the high-beam reflecting mirror, to form the modular reflecting cup module.

18. The reflection-type headlamp module according to claim 17, wherein the low-beam reflecting cup, the low-beam reflecting mirror, the high-beam reflecting mirror and the high-beam reflecting cup are integrally molded to form the reflecting cup module.

19. The reflection-type headlamp module according to claim 17, wherein the low-beam reflecting cup is shaped as an ellipsoid surface or an ellipsoid-like surface, a light emitter of the low-beam light source is located at a first focus of the low-beam reflecting cup, and the low-beam reflecting mirror is located at a second focus of the low-beam reflecting cup;
the high-beam reflecting cup is shaped as an ellipsoid surface or an ellipsoid-like surface, a light emitter of the high-beam light source is located at a first focus of the high-beam reflecting cup, and the high-beam reflecting mirror is located at a second focus of the high-beam reflecting cup; and
a cutoff line structure is formed on a junction of the low-beam reflecting mirror and the high-beam reflecting mirror, and the cutoff line structure is located in a second focus region of the low-beam reflecting cup.

20. A headlamp, comprising the reflection-type headlamp module according to claim 1.
